(19) United States
(12) Patent Application Publication
(10) Pub. No.: US 2019/0153241 A1
(43) Pub. Date: May 23, 2019

(54) Non-stick Siloxane Compositions Having a Low Water Roll Off Angle

(71) Applicant: Ross Technology Corporation, Leola, PA (US)

(72) Inventors: Saibal Bandyopadhyay, Lancaster, PA (US); Andrew K. Jones, Lancaster, PA (US)

(21) Appl. No.: 15/932,453

(22) Filed: Nov. 17, 2018

Related U.S. Application Data
(60) Provisional application No. 62/588,132, filed on Nov. 17, 2017.

(51) Int. Cl. C09D 5/16; C09D 4/00

(52) U.S. Cl. CPC C09D 5/1675; C08G 77/045; C09D 4/00

(57) ABSTRACT

The present disclosure is directed to methods of forming internally lubricated non-stick articles, and coatings, having a low water roll off angle. Also disclosed are materials and compositions for use in the disclosed methods, and the articles and coatings produced by the disclosed methods. The articles and coatings find use in a variety of applications in the biomedical area and in the prevention of biological fouling, such as that which occurs in marine environments.

### PRIORITY

This application claims the benefit of U.S. Provisional Application No. 62/588,132 filed Nov. 17, 2017, the contents of which is incorporated by reference in its entirety.

### BACKGROUND

The present disclosure is directed to the use of siloxane polymers containing siloxane/silicone oils dispersed throughout the polymer. Those polymer compositions find use in numerous applications including bio/medical applications and in environments where fouling from a biological process may arise. In the bio/medical area these materials are particularly useful where resistance to the adhesion of cells, proteins, carbohydrates, and related biological materials is desired.

### SUMMARY

The present disclosure is directed to methods of forming internally lubricated articles, including coatings, that have a low water roll off angle and which resist adhesion of cells, proteins, carbohydrates and related biological materials. In one embodiment the method comprises: i) combining polymerizable monomers, functionalized oligomers, and/or functionalized polymers, which can be polymerized to prepare silicone elastomers, with a first lubricating fluid to form an internally lubricated pre-polymer composition; ii) curing the internally lubricated pre-polymer composition by polymerizing the monomers, functionalized oligomers, and/or functionalized polymers to form a cured article; and iii) optionally applying a second lubricating fluid to all or part of the surface of the cured article, thereby forming an internally lubricated article having a low water roll off angle. Also disclosed are materials and compositions for use in the disclosed methods, and materials and articles produced by the disclosed methods.

The materials and articles find use in a variety of applications including bio-medical applications. Because the surfaces of objects formed from the siloxane polymer compositions described herein can be hydrophobic or hydrophobic and oleophobic, such materials find particular use where articles are in contact with tissue and/or biological fluids. The properties of the materials make articles prepared from them resist fouling and clogging. Articles prepared from the internally lubricated materials described herein resist colonization by bacteria (e.g., their glycocalyx cannot hind them to the surface). The inability of bacteria to effectively bind and colonize the surfaces of the articles reduces the incidence of persistent infection and even bacterially induced mineral deposition (e.g., struvite and/or hydroxylapatite precipitation from urine).

The compositions described herein also find use in the marine environment. Accumulation of marine microorganisms, plants and marine species (barnacles) on items found in marine environments such as buoys and boat hulls affects their durability and performance. Accumulation of such materials on boat hulls can affect a vessel's durability and fuel economy. The disclosed fluid infused silicone-based articles/coatings can reduce the number, type and/or growth rate of marine/subaquatic organisms on solid surfaces. Applied to boat bottoms, the coatings described herein can reduce the development of drag (rate of drag increase) caused by the growth/attachment of marine organism on boat hulls/bottoms. The reduction in the growth/attachment of organisms to boat hulls and equipment leads to both a reduction in maintenance and attendant costs and an increase in fuel economy.

### BRIEF DESCRIPTION OF THE DRAWINGS

FIG. 1 shows the initial water slide angle (WSA) of three different PDMS fluid treated samples and the WSA following various amounts of abrasion of the sample using a Taber Abraser (Model 503) equipped with CS-0 wheels at a 250 g load.

FIG. 2 shows the initial water slide angle (WSA) of three different formulations (I, II, and III) before and after various amounts of abrasion by a Taber Abraser equipped with CS-0 wheels at a 250 g load.

FIG. 3 shows the initial water slide angle (WSA) of two different formulations (Formulations II and III) before and after various amounts of abrasion on a linear Taber Abraser (Linear Fabric Abraser) equipped with CS-0 wheels at a 250 g load.

FIG. 4 shows the initial water slide angle (WSA) of SYLGARD® 184 (Formulation 0) and Formulation I coatings on aluminum plates and the WSA at the indicated times after the samples were subject to a stream of running water.

FIG. 5 shows images of aluminum plates treated with Formulation II (left), Formulation III (center) and an uncoated aluminum control plate (right) after 67 days submerged in the ocean.

FIG. 6 shows the results of submerging aluminum plates coated with formulations 4-I to 4-VI and control aluminum plates in water off the coast of Ocean City, Md., as described in Example 4. Panel (a) shows the plates before submersion and panel (b) shows the plates after 110 days of submersion without rinsing.

FIG. 7 shows the results of submerging aluminum plates coated with formulations 4-1 to 4-VI and control aluminum plates in water off the coast of Galveston, Tex., as described in Example 4. Panel (a) shows the plates before submersion, panel (b) shows the plates after 107 days of submersion, panel (c) shows the plates after 250 days of submersion, and panel (d) shows the plates after 383 days of submersion. The photos taken in panels (b) (c) and (d) were taken after a brief rinse with fresh water as described in Example 4.

### DETAILED DESCRIPTION

### 1.0 Definitions

For the purposes of this disclosure, a hydrophobic (HP) material or surface is one that results in a water droplet forming a surface contact angle exceeding about 90° at room temperature (22° C. for the purposes of this disclosure). Similarly, for the purposes of this disclosure, a superhydrophobic (SH) material or surface is one that results in a water droplet forming a surface contact angle exceeding 150° but less than the theoretical maximum contact angle of 180° at room temperature. For the purposes of this disclosure the term hydrophobic (HP) shall include superhydrophobic (SH) behavior unless stated otherwise. Any and all embodiments, claims, and aspects of this disclosure reciting hydrophobic behavior may expressly include, and thus may be limited to, either hydrophobic behavior that is not superhydrophobic (contact angles from 90°-150°) or superhydrophobic behavior (contact angles of 150° or greater). As SH surface behavior encompasses water contact angles from greater than 150° to 180°, SH behavior is considered to include what is sometimes referred to as “ultra-hydrophobic” behavior.

The abbreviation HP/OP as used herein indicates both hydrophobic and oleophobic properties.

“Roll off angle,” “slide angle,” or “water slide angle” (WSA) as used herein is the angle from horizontal at or above which more than half the droplets of a liquid (e.g., water, hexadecane, or light mineral oil) placed on a planar surface will not remain stationary and will roll to the edge or roll off the surface. Unless stated otherwise, roll off angle measurements are conducted at room temperature.

As used herein, room temperature means 22° C.

As used herein, “HP-particles” refers to particles that are hydrophobic or particles that are hydrophobic and oleophobic, with a size from about 1 nanometer (nm) to about 150 μm, employed to impart HP or HP/OP behavior into coatings and materials. Particles and surfaces that display HP behavior may, or may not, display oleophobic properties.

A “micro-texture” is a surface texture that promotes hydrophobic behavior by encouraging Cassie-type interactions of certain liquids with the surface. A “micro-pattern” is a micro-texture that repeats itself more than three times. Micro-textures and micro-patterns as used herein have an arithmetical mean roughness in a range selected from about 15 microns to about 500 microns (e.g., about 15 microns to about 35 microns, about 25 microns to about 75 microns, about 50 microns to about 100 microns, about 75 microns to about 100 microns, about 75 microns to about 150 microns, about 100 microns to about 150 microns, about 100 microns to about 200 microns, about 125 microns to about 175 microns, about 150 microns to about 200 microns, about 175 microns to about 250 microns, about 200 microns to about 250 microns, about 200 microns to about 300 microns, about 225 microns to about 300 microns, about 250 microns to about 350 microns, about 300 microns to about 400 microns, about 350 microns to about 450 microns, or about 400 microns to about 500 microns).

For the purposes of this disclosure, an oleophobic (OP) material or surface is one that results in a droplet of light mineral oil forming a surface contact angle exceeding about 90°. Similarly, for the purposes of this disclosure a superoleophobic (SOP) material or surface is one that results in a droplet of light mineral oil forming a surface contact angle exceeding 150° but less than the theoretical maximum contact angle of 180° at room temperature. For the purposes of this disclosure the term oleophobic (OP) shall include superoleophobic (SOP) behavior unless stated otherwise. Any and all embodiments, claims, and aspects of this disclosure reciting oleophobic behavior may expressly include, and thus may be limited to, either oleophobic behavior that is not superoleophobic (contact angles from 90°-150°) or superoleophobic behavior with contact angles of 150° or greater.

The term “light mineral oil” as used herein refers to white mineral oil with: a specific gravity at 25° C. of 0.869 to 0.885 g/cc per ASTM D4052; a kinematic viscosity of 64.5 to 69.7 mm²/s at 40° C. per ASTM D445; and a Saybolt viscosity of 340 to 360 SUS at 100° F. perASTM D2161 (KAYDOL® 74a, Sonneborn, Inc., Parsippany, N.J.).

Silicone fluid, as used herein, refers to compositions consisting substantially of one or more siloxanes having a melting point less than 22° C. Unless stated otherwise, silicone fluids were purchased from Clearco Products Co. Inc., Bensalem, Pa., and viscosities were as reported by the manufacturer.

The viscosity of silicone fluids and other lubricating fluids may be determined by any suitable test including ASTM D445-15a at 20° C.

Cured, as used herein, means that most of the reactive groups present on monomers, oligomers, and polymers that can undergo reaction to form polymerized material have undergone reaction. Unless stated otherwise, cured does not mean “fully cured,” in which substantially all such reactive groups have undergone reaction with a reactive group on another monomer, oligomer, or polymer, or with a capping or terminating agent.

Weight percent or percentages by weight are limited to a total of 100%. Where less than 100% of the contents of a composition are stated, the remainder (balance) of the composition comprises other unlisted components such as, for example, solvents, fillers, etc.

For the purpose of this disclosure salt water or seawater is understood to refer to bodies of water (e.g., oceans and seas) that contain greater than 30 parts per thousand (on a weight basis) of salts, brackish waters are understood to contain 0.5 to 30 parts per thousand of salts, and fresh water contains less than 0.5 parts per thousand of salts.

Throughout this disclosure a variety of properties for articles and materials prepared using the siloxane polymer compositions are described (e.g., tubing, shunts, ports, catheters, coatings, and the like). Where the articles are too small for effective measurements to be conducted on the surfaces, a measure of the properties may be made on suitably sized flat samples prepared from the same materials under substantially the same conditions

### 2.0 Curable Silicone Compositions

The internally lubricated articles described herein are prepared by combining polymerizable monomers, functionalized oligomers, and/or polymers, which can be cured to prepare silicone elastomers, with a first lubricating fluid to form an internally lubricated pre-polymer composition. After curing, the cured article comprises a silicone elastomer due to polymerization of the polymerizable monomers, functionalized oligomers, and/or polymers. In some embodiments polymerizable monomers, oligomers and/or polymers used in the uncured composition may be siloxanes or comprise siloxane moieties. Where functionalized oligomers and/or polymers are used to form the elastomeric component of the cured article, they may be functionalized with groups that permit the formation of elastomer at either the ends of oligomer chains or at locations other than the ends of oligomer chains. For example:

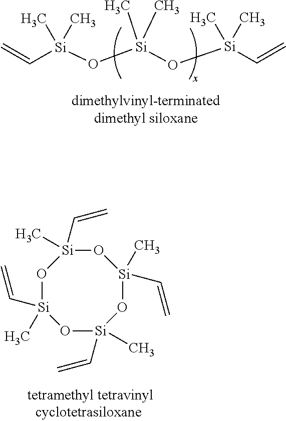

In some embodiments the silicone elastomer component of the articles (e.g., the coating) is formed using a heat curing composition, which is generally heated in the presence of a catalyst such as Karsted's catalyst or H₂PtCl₆. In such circumstances elastomer formation may occur through a hydrosilylation reaction. In those embodiments where effective room temperature curing is desired, the type and amount of catalyst may be varied. Among the catalysts that may be employed to achieve effective room temperature curing are organo-metallic catalysts (e.g., organo-platinum catalyst) such as Dow Corning Q3-6659 catalyst.

In some embodiments the silicone elastomer is formed using a UV/Vis curing composition. The composition is subject to UV and/or Visible light exposure concurrent with or following the application, forming, or shaping of the uncured internally lubricated pre-polymer composition (e.g., placing the composition into a mold), or applying HP/OP particles in contact with the uncured composition (e.g., spray application of HP-particles upon an uncured coating). In other embodiments, the internally lubricated pre-polymer composition is a moisture cure composition and the article is exposed to an atmosphere comprising moisture. Regardless of whether the silicone pre polymer composition comprises a UV/Vis and/or a moisture cure silicone, the article may be heated to speed the curing time and to drive off any volatile materials generated in the curing (e.g., methanol, acetone, or even acetic acid generated by acetoxy silicones). Dual-cure silicones that can also undergo moisture cure prior to, concurrent with, or subsequent to UV or visible photo-initiated polymerization/curing may also be employed to prepare HP/OP tubing.

A number of products are commercially available that employ polymerizable monomers, functionalized oligomers, and/or polymers which can be cured to prepare silicone elastomers, including those in Table 1.

TABLE 1

| | | | Temperature | | | | | |
|---|---|---|---|---|---|---|---|---|
| | | Viscosity | Range in | | | | | |
| Binder & | | (centipoises or | Degrees | Shore | Modulus | Elongation | Tensile | |
| Cure Method | Appearance | “cp”) | Centigrade | Hardness | (psi) | (%) | (in.) | Comments |
| Nuva-Sil ® | Translucent/ | 25,000 cp | −65 to 200 | 45(A) | 145 | 350 | 435 | High viscosity, high |
| Silicone 5240 | White | | | | | | | tear strength, cures in |
| UV/Vis & | | | | | | | | shadowed areas |
| Moisture | | | | | | | | |
| Nuva-Sil ® | Transparent/ | 525 cp | −65 to 300 | 55(A) | 650 | 80 | 870 | Low viscosity, high |
| Silicone 5055 | Light yellow | | | | | | | adhesion to silicone |
| UV/Vis | | | | | | | | and polycarbonate |
| Nuva-Sil ® | Transparent/ | 2200 cp | −65 to 300 | 43(A) | 195 | 170 | 765 | Medium viscosity, |
| Silicone 5056 | Light yellow | | | | | | | superior heat and |
| UV/Vis | | | | | | | | humidity resistance |
| NovaGuard | | | −54-260 | | | | | |
| UV ® | | | | | | | | |
| Dow Corning ® | Aluminum, | | −60 to 177 | | | | | FDA- and NSF- |
| 732 | Black, white, & | | | | | | | approved |
| Acetoxy | clear | | | | | | | |
| Moisture cured | | | | | | | | |
| Dow Corning ® | | | | | | | | FDA- and NSF- |
| 748 | | | | | | | | approved |
| Alkoxy | | | | | | | | |
| Moisture cured | | | | | | | | |
| Dow Corning ® | Gray two part | 4000 | | | | | | |
| Sylgard ® 160 | silicone | | | | | | | |
| | elastomer | | | | | | | |
| Dow Corning ® | Gray two part | 5000 | | | | | | |
| Sylgard ® 165 | silicone | | | | | | | |
| | elastomer | | | | | | | |
| Dow Corning ® | Dark | 2900 | | | | | | |
| Sylgard ® 170 | gray to | | | | | | | |
| Silicone | black | | | | | | | |
| Elastomer | | | | | | | | |
| Dow Corning ® | Dark | 2850 | | | | | | |
| Sylgard ® 170 | gray to | | | | | | | |
| Fast Cure | black | | | | | | | |
| Silicone | | | | | | | | |
| Elastomer | | | | | | | | |
| Dow Corning ® | Colorless two | 3500 cp | | | | | | |
| Sylgard ® 182 | part silicone | mixed | | | | | | |
| | elastomer | | | | | | | |
| Dow Corning ® | Colorless two | 3500 cp | | | | | | |
| Sylgard ® 184 | part silicone | mixed | | | | | | |
| | elastomer | | | | | | | |
| Dow Corning ® | Translucent | 25,000 | | | | | | |
| 3-6121 | | | | | | | | |
| Encapsulating | | | | | | | | |
| Elastomer | | | | | | | | |

Embodiments of the compositions and methods described herein may utilize monomers, functionalized oligomers, and/or functionalized polymers that can be polymerized to prepare silicone elastomers by hydrosilylation. In one group of such embodiments, the polymerizable monomers may be selected independently from: (i) telechelic linear and/or branched siloxanes with vinyl terminal groups; (ii) telechelic linear and/or branched siloxanes with hydrosilane terminal groups; (iii) telechelic linear and/or branched siloxanes with acrylate and/or methacrylate terminal groups; and (iv) combinations of any two, three or more thereof. In another group of such embodiments, the methods and composition may utilize chain terminating monomers selected independently from: (i) monovinyl terminated symmetric polysiloxane; (ii) monovinyl functionalized tris polysiloxane; (iii) mono acryloxy propyl functionalized symmetric polysiloxane; (iv) mono acryloxy propyl functionalized tris polysiloxane; and combinations; and (v) combinations of any two, three or more thereof. Any combination of one two, three or more of the aforementioned hydrosilylation monomers and chain terminating monomers may also be employed.

In addition to the monomers, oligomers, and polymers employed in hydrosilylation polymer reactions, reactive additives may be utilized to prepare the silicone elastomers. Those reactive additives include, but are not limited to, crosslinking agents capable of forming multiple crosslinks (three, four, or more bonds) to polymer chain components and reactive modifiers. In one embodiment, the reactive additive is a crosslinking agent such as tetravinyl-cyclotetrasiloxane. In other embodiments, the reactive additive may be reactive particles that are capable of forming covalent linkages with the siloxane elastomer (polymer) during curing. Such reactive particles include, but are not limited to, hydrosilane functionalized particles and/or vinyl silane (e.g., vinyl trimethoxy silane or vinyl triethoxy silane) functionalized particles. The particles include silica, titanium dioxide, and other organic and/or inorganic particles used to prepare HP- or HP/OP-particles. Such functionalized particles not only serve as crosslinking agents but may also serve as rheological agents in the uncured compositions. The reactive additives, including particles that can crosslink the polymers formed during curing, may also increase the hardness (e.g., Shore A/Shore D or pencil test hardness) of the articles and coatings formed with coating compositions and methods described herein. Such reactive particles may be HP- or HP/OP-particles bearing olefins that can undergo hydrosilylation reactions, such as vinyl groups.

In one embodiment, the compositions do not comprise tetravinyl-cyclotetrasiloxane.

In other embodiments the compositions and methods described herein may utilize monomers, functionalized oligomers, and/or functionalized polymers that can be polymerized to prepare silicone elastomers by condensation (moisture cure) reactions. In one group of such embodiments, the monomers and oligomers may be selected independently from: (i) telechelic linear or branched siloxane with trialkoxy silane terminal groups; (ii) telechelic linear or branched siloxane with silyl tris acetate terminal groups; (iii) telechelic linear or branched siloxane with silyl tris enolate (acetone) terminal groups; (iv) copolymers of monoacryloxy and/or monomethacryloxy terminated polysiloxane copolymerized with methacryloxy propyl trialkoxy silane or acryloxy propyl trialkoxy silane; and (v) combinations of any two, three or more thereof. In addition to the foregoing, crosslinking and reactive modifiers may be utilized in the methods and compositions employing condensation curing siloxanes. One group of reactive modifiers that can act as both a crosslinking agent and a rheological agent in the uncured compositions is particles (e.g., silica, titanium dioxide, and other organic/inorganic particles such as inorganic oxides used to prepare HP or HP/OP particles discussed below) bearing one, two, three or more of the monomers and/or oligomers described above, provided that the particles retain at least three terminal reactive groups per particle.

Ultraviolet (UV), Visible (Vis) or UV/Vis reactive (photo reactive or photo-initiated) systems may be employed in the compositions and methods described herein. Where such light-based systems are employed they may utilize monomers, functionalized oligomers, and/or functionalized polymers that can be polymerized to prepare silicone elastomers by light based or light initiated reactions. In one group of such embodiments, the monomers and oligomers may be linear and/or branched polysiloxane with acrylate or methacrylate end groups. Reactive modifiers comprising particles (e.g., silica, titanium dioxide, and other organic/inorganic particles such as inorganic oxides used to prepare HP or HP/OP particles discussed below) bearing multiple acryloxy propyl and/or methacryloxy propyl trialkoxy silane groups may be used as crosslinkers and rheological modifiers of the uncured materials.

### 3.0 Lubricating Fluids

A variety of fluids, referred to herein as “lubricating fluids,” may be utilized to modify the properties of articles prepared using lubricated pre-polymer compositions, including contributing to the hydrophobicity and oleophobicity of the article's surface. The fluids may also contribute to the properties of the article/coating including the inability of materials to adhere to the article's surface, act as a lubricant for the article surface, and reduce the contact and/or roll off angle of water or oil droplets on the surface.

A variety of lubricating fluids may be employed as the first lubricating fluid and/or the second lubricating fluid. In an embodiment the first and second lubricating fluids are selected independently from alkanes, fluoroalkanes, alkenes, fluoroalkenes, silicone fluids, mineral oils, plant oils, fatty esters (e.g., of ethylene glycol, propylene glycol or glycerol), fatty ethers (e.g., alkyl or alkenyl ethers of ethylene glycol, propylene glycol or glycerol), phosphate esters, silicate esters and mixtures thereof. Lubricating fluids are not understood to encompass fluids that comprise functional/reactive groups that permit them to become covalently attached to the silicone polymers during curing. In an embodiment the first and/or second lubricating fluids do not include functional/reactive groups that permit their covalent incorporation into the siloxane polymers during polymerization by hydrosilylation. In an embodiment the first and/or second lubricating fluids do not include functional/reactive groups that permit their covalent incorporation into the siloxanc polymers during polymerization by condensation. In another embodiment, the first and/or second lubricating fluids do not include functional/reactive groups that permit their covalent incorporation into the siloxane polymers during photo-initiated polymerization (UV or UV/Vis polymerization).

In an embodiment, the first lubricating fluid and/or the second lubricating fluid may be silicone fluids selected independently from alkyl or fluoroalkyl silicone fluids comprising 2, 3, 4, 5, 10, 15, 20, 25, 30, 40, 50, 100 or more groups of the form:

(—O—Si(G1)(G2)-)

where each G1 and G2 is selected independently from the group consisting of methyl, ethyl, propyl, isopropyl, n-butyl, isobutyl, sec-butyl, phenyl, and chloro-phenyl, any or all of which may be fluorinated. In an embodiment each G1 and G2 is selected independently from the group consisting of methyl, ethyl, propyl, isopropyl, n-butyl, isobutyl, and sec-butyl, any or all of which may be fluorinated. Linear siloxane chains found in silicone fluids generally end in trialkyl silane moieties, with linear siloxanes having a structure such as: (G1)₃Si(—O—Si(G1)(G2))_{g} O—Si(G1)₃, where G1 and G2 are as defined above and “g” is the number of repeating siloxane units in the molecule. In another embodiment the first lubricating fluid and/or the second lubricating fluid comprise independently selected silicone fluids. In another embodiment, the first lubricating fluid and/or the second lubricating fluid comprise independently selected linear or branched silicone fluids, any or all of which may be fluorinated. In another embodiment, the first lubricating fluid and/or the second lubricating fluid comprise independently selected polydimethylsiloxanes (PDMS) and/or polydiethylsiloxanes (PDES), any or all of which may be fluorinated.

In another embodiment, the first and/or second lubricating fluids comprise one or more phenyl and/or diphenyl silicones, which have one or two phenyl groups per siloxane molecule respectively. In other embodiments the first and/or second lubricating fluids comprise trifluoromethyl, trifluoroethyl, and/or trifluoropropylmethyl constituent groups.

In one embodiment, where the first and/or second lubricating fluids are siloxanes, the lubricating fluids do not include more than 1% (or alternatively 5%) by weight of D4, D5 and/or D6 cyclic siloxanes. In other embodiments, the first and/or second lubricating fluids do not include more than 0.5% (or alternatively 1% or 5%) by weight of a siloxane (siloxanes) that has (have) a molecular weight less than 250, 300, 350, 400, or 450 grams/mole. In other embodiments, the first and/or second lubricating fluids comprise less than 1% (or alternatively 5%) by weight of a PDMS fluid that in its pure state would have a viscosity less than 1 cSt, 2 cSt, 3 cSt, or 4 cSt at 20° C. under ASTM D445-15a. In any embodiment, the first and/or second lubricating fluids comprise less than 0.5% (or alternatively 1%, 2%, 3% or 5%) by weight of tetra(trimethylsiloxy)silane. In one embodiment, the articles described herein may comprise a first lubricating fluid (the first lubricating fluid may comprise one or more lubricating fluids) that is distributed throughout a polymer composition used to form all or part of an article. Distributing lubricating fluids in, and even uniformly or non-uniformly throughout, the polymer composition may be accomplished by contacting the polymer component of the article (e.g., the coating), or the entire article, with the lubricating fluid(s) and allowing the fluids to permeate the cured or partially cured polymer. Heat, pressure/reduced pressure (partial vacuum), and/or carrier solvents may be utilized. Where carrier solvents are utilized, those that cause the polymer to swell and which are volatile enough to be removed using heat and/or reduced pressure (e.g., partial vacuum) may be most beneficial. Alternatively, the lubricating fluid(s) may be distributed throughout a pre-polymer composition used to form all or part of an article by mixing the fluid(s) with the uncured (unpolymerized) components used to prepare the article. In such a method of forming an internally lubricated article or part thereof, fluid(s) are distributed throughout the article by: i) combining polymerizable monomers, functionalized oligomers, and/or functionalized polymers, which can be polymerized to prepare silicone elastomers, with a first lubricating fluid (e.g., a mix of one or more lubricating fluids) to form an internally lubricated pre-polymer composition; and ii) curing the internally lubricated pre-polymer composition by polymerizing the monomers, functionalized oligomers, and/or functionalized polymers to form a cured article or cured part of an article. Where the polymer comprises one or more chemical groups that can be modified by reaction with silanizing agents (e.g., compounds of formula (I)), the use of such agents to render the polymer more hydrophobic/oleophobic prior to the introduction of the first or second silanizing agent may produce beneficial effects. Those effects can include an increased ability of the treated polymer to retain the lubricating fluids applied to it and increased oleophobicity and/or hydrophobicity (e.g., as reflected in reduced roll off angles for water and oils).

In another embodiment, an article in which a first lubricating fluid is distributed throughout the article may be treated with a second lubricating fluid (the second lubricating fluid may comprise one or more lubricating fluids) by applying a second lubricating fluid to all or part of the surface of the cured article. The second fluid may be applied to the article undiluted or mixed with a compatible carrier solvent. As discussed above for the application of first lubricating fluids, where carrier solvents are utilized, those that cause the polymer to swell and which are volatile enough to be removed using heat and/or reduced pressure (e.g., partial vacuum) may be most beneficial. Carrier solvents may include cyclic siloxanes (e.g., D4, D5, D6 and/or combinations of those cyclic siloxanes).

Applying the second lubricating fluid to the surface of the article or part thereof can result in a variety of different embodiments. In one embodiment the second lubricating fluid will remain primarily on the surface of the article. In another embodiment, the majority of the second lubricating fluid will remain substantially on the surface and/or in the outermost regions of the article (e.g., the outer 0.1, 0.2, 0.5, 1.0 or 2.0 mm of the article). In yet another embodiment, the second lubricating fluid penetrates the article, forming a gradient having the highest amount at the surface where the fluid was applied, the amount of the second lubricating fluid decreasing as the depth below the surface increases.

Application of the lubricating fluids to an article, and particularly an article prepared with siloxane-containing polymers (e.g., elastomers), permits formation of internally lubricated articles, including those which have a low water roll off angle and which resist the adherence (sticking) of materials that may foul a surface (e.g., undergo partial or complete blockages of tubes or passages or attachment of foreign matter). Materials that may foul an article's surface or passages in an article, particularly articles used in bio-medical applications, include proteins, glycoproteins, carbohydrates, polysaccharides (e.g., bacterial glycocalyx), nucleic acids, lipids, mineral deposits, blood clots, scar tissue, arterial plaque, and mixtures of any of those materials. By using two or more lubricating fluids applied as the first lubricating fluid or as the first and second lubricating fluids, it is possible to control the surface properties of an article and how those properties evolve over time. For example, articles prepared from an internally lubricated polymer with a first lubricating fluid distributed throughout the article may have the ability to resist clogging and fouling. The use of a second lubricating fluid, applied to the surface of the article or with a concentration gradient, may permit the article to resist fouling for a longer period of time under the same conditions, particularly where the first lubricating fluid has a lower viscosity and ability to diffuse to the surface of the polymer matrix than the second fluid, which is intended to stay substantially at or near the surface of the article after it is applied.

In some embodiments the first lubricating fluid is the same as the second lubricating fluid. In such embodiments the first and second lubricating fluids may comprise one, two, three, four or more lubricating fluids.

In another embodiment, the first and second lubricating fluids are different. In such an embodiment the first and second lubricating fluids may comprise one, two, three, four or more lubricating fluids that are selected independently.

In any of the above-mentioned embodiments, the first and/or second lubricating fluids each have a kinematic viscosity at a range selected independently from about 1 or about 2 cSt (centiStokes) up to 1,000 cSt (e.g., 2-5, 3-7, 2-10, 2-100, 4-20, 4-25, 4-50, 7-15, 7-20, 10-30, 10-50, 10-100, 20-40, 20-50, 20-70, 20-100, 30-50, 30-70, 30-100, 40-80, 40-100, 50-75, 50-100, 80-100, 50-200, 100-300, 200-400, 300-500, 400-600, 500-700, 600-800, 700-900, or 800-1,000 cSt) at 20° C. In such an embodiment, the first and second lubricating fluids have a difference in kinematic viscosity greater than 1, 2, 5, 7, 10, 20, 30, 40, 50, 60, 70, 80, 90, 100, 200, 300, 400, 500, 600, 700, 800, or 900 cSt, where the kinematic viscosity is determined at 20° C. In another such embodiment, the first and second lubricating fluids have a difference in kinematic viscosity in a range selected from the group consisting of about 2 to about 7, about 2 to about 10, about 3 to about 15, about 4 to about 10, about 5 to about 25, about 10 to about 25, about 15 to about 30, about 15 to about 50, about 25 to about 50, about 25 to about 75, about 30 to about 60, about 30 to about 90, about 40 to about 80, about 50 to about 100, about 50 to about 200, about 100 to about 300, about 200 to about 400, about 300 to about 500, about 400 to about 600, about 500 to about 700, about 600 to about 800, about 700 to about 900, and about 800 to about 1,000 cSt, where the kinematic viscosity is determined at 20° C.

In some embodiments the first and/or second lubricating fluids will comprise, consist essentially of, or consist of silicone fluids. When the first and/or second lubricating fluids comprise a silicone fluid, the silicone fluid may comprise, consist essentially of, or consist of one, two, three, four or more linear and/or cyclic siloxanes where: (i) greater than 50%, 60%, 70%, 80%, 90%, or 95% of the siloxane molecules in said silicone fluid have a molecular weight less than 6,000, 5,000, 4,000, 3,000, 2,000, 1,000, 900, 800, 700, 600, 500, 400, or 300 Daltons; (ii) greater than 50%, 60%, 70%, 80%, 90%, or 95% of the siloxane molecules in said silicone fluid have a molecular weight in a range selected from the group consisting of 6,000-5,000, 6,000-3,000, 5,000-4,000, 4,000-3,000, 4,000-1,000, 3,000-2,000, 3,000-1,000, 2,000-1,000, 2,000-200, 1,000-900, 1,000-500, 1,000-200, 900-800, 800-700, 800-250, 700-500, 700-200, 600-250, 500-250, 500-200, 400-250 and 400-200 Daltons; (iii) the silicon fluid has a melting point less than 0, 5, 10, 12, 14, 16, 18, or 20° C.; and/or (iv) the silicone fluid has a kinematic viscosity less than a value selected from the group consisting of 100, 75, 50, 25, 10, 9, 8, 7, 6, 5, 4, 3, 2, 1, 0.9, 0.8, and 0.7 centiStokes (cSt) at 25° C. In such embodiments, the silicone fluids may be comprised of linear siloxanes, branched siloxanes and/or cyclic siloxanes bearing alkyl groups. In such embodiments, each alkyl group present on the alkyl siloxanes is an independently selected one to four carbon (C1-C4) alkyl group that may be fluorinated. Alternatively, each alkyl group is independently selected from methyl, ethyl, or n-propyl, any or all of which may be fluorinated. Alternatively, each alkyl group is a methyl group. Where the first and/or second lubricating fluids comprise a linear siloxane, which may be fluorinated, the siloxanes may be an alkyl siloxane (e.g., each alkyl group present is independently selected from C1-C4 alkyl or each alkyl group present is independently selected from methyl or ethyl, or each alkyl group is methyl).

Where a carrier solvent is employed with the first and/or second lubricating fluids, the solvent may comprise, consist essentially of, or consist of one or more solvents selected from the group consisting of: pentane; hexane; heptane; octane; nonane; decane; petroleum ether with a distillation range of 30 to 40° C., 30 to 50° C., 35 to 60° C., 40 to 60° C., 60 to 80° C., 80 to 100° C., or 80 to 120° C.; cyclopentane; cyclohexane; cycloheptane; cyclooctane; cyclononane; cyclodecane; benzene; toluene; 1,2-dimethylbenzene; 1,3-dimethylbenzene; 1,4-dimethylbenzene; methylformate; ethylformate; methylacetate; ethylacetate; propylacetate; butylacetate; n-butylacetate; sec-butylacetate; tertbutylacetate; acetone; methylethylketone; methylisobutyl ketone; diethyl ether; dimethyl ether; methyl ethyl ether; methyl butyl ether; ethyl butyl ether; tert-butyl ether; hexamethylcyclotrisiloxane (D3); octamethylcyclotetrasiloxane (D4); decamethylcyclopentasiloxane (D5); dodecamethylcyclohexasiloxane (D6); and mixtures thereof.

### 4.0 Hydrophobic or Hydrophobic and Oleophobic Particle

Where particles that contribute to HP or HP/OP behavior are employed in the materials and methods described herein, particles that display HP or HP/OP behavior are generally employed. Where the particles are prepared from particulate materials that are not sufficiently hydrophobic or oleophobic (e.g., a layer of the particles spread on a planar surface has a contact angle less than 105°), the particles, which are denoted “precursor particles,” can be modified to increase their water-repellent and/or oil-repellent behavior. In some embodiments, the precursor particles are treated with materials that will non-covalently bond or result in the association of hydrophobic compounds or molecules with the precursor particles. Some compounds, such as siloxanes (e.g., polydimethylsiloxane or PDMS), can tightly bind precursor particles comprised of some materials (e.g., silica or alumina). Once bound, materials such as siloxanes can be converted to covalently bound groups or moieties by various treatments, such as heating. In other embodiments, precursor particles are contacted with reagents that covalently bind to the particles groups or moieties that increase the hydrophobic and/or oleophobic behavior of the particles. Accordingly, hydrophobic groups, moieties, and compounds can be associated with the particles non-covalently or covalently.

Among the hydrophobic groups or moieties that can be introduced into/on precursor particles to increase their HP and/or OP behavior are siloxanes, hydrocarbons, and fluorinated hydrocarbons (fully or partially fluorinated hydrocarbons). In some embodiments, the groups or moieties introduced into/on precursor particles are bound to the particles through one or more intervening atoms that arise from reactive groups on the precursor particles reacting with chemical agents (e.g., silanizing agents) used to introduce the siloxanes, hydrocarbons, and fluorinated hydrocarbons.

While HP- or HP/OP-particles can be present in a cured article produced by the current methods without any covalent bonds to the polymer matrix, in some embodiments those particles are covalently linked to the matrix (e.g., during curing/polymerization). Various functional groups, including alkenes, can be utilized to facilitate the formation of covalent bonds between the particles and the polymer matrix. In an embodiment, precursor particles are covalently bound to the matrix, through one or more functionalities introduced onto the precursor particles prior to combining those particles with monomers, oligomers, and/or polymers that will be cured to form an article. In one embodiment where the particles are covalently bound to the matrix, the particles comprise covalently bound alkene functionalities in addition to any siloxane, hydrocarbon (alkyl groups) and/or fluorinated hydrocarbon (fluoroalkyl groups) functionalities prior to combining those particles with monomers, oligomers, and/or polymers that will be polymerized. In another embodiment the particles comprise covalently bound polymer initiators or chain transfer agents (e.g., 3-trimethyloxysilyl)propyl 2-bromo-2-methylpropionate available from Gelest as product SIT8397) in addition to siloxane, hydrocarbon and/or fluorinated hydrocarbon functionalities prior to combining those particles with monomers, oligomers, and/or polymers that will be cured to form an article. In still another embodiment the precursor particles comprising covalently bound polymer initiators or chain transfer agents (e.g., 3-trimethyloxysilyl)propyl 2-bromo-2-methylpropionate) are combined with monomers or oligomers (e.g., methacrylate, methyl methacrylate, glycidyl methacrylate or 3-(trimethoxysilyl)propyl methacrylate) and polymerization initiated to yield polymer chains attached to the particles, or polymer coated particles. In any of the forgoing embodiments where particles are incorporated into the cured article and the particles have an insufficient amount of groups to provide the desired level of HP or HP/OP behavior, the cured article may be treated to introduce siloxane, alkyl, and/or fluoroalkyl groups onto the particles (e.g., treating the cured materials with a silizane, siloxane, or silanizing agent of formula (I)). In such embodiments, the average number of sites where a particle has a siloxane, alkyl, or fluoroalkyl group that is covalently bound to the particle may be greater than or equal to the average number of sites where the particle is bound to the polymer matrix. The average number of each type of site can be estimated by a variety of means including the ratio of the reagents used to treat the precursor particles. For example, where the particles are treated with a trimethyloxysilyl silanizing agent of formula (I) and an initiator such as 3-(trimethoxysilyl)propyl methacrylate, the molar ratio of the silanizing agent and the initiator can be used as an estimate of the ratio of HP/OP groups and particle-polymer chain linkages.

In embodiments, HP- or HP/OP-particles suitable for use in the methods and articles described herein have a size from about 1 nanometer (nm) to about 150 μm. Those particles can be hydrophobic or, if the groups or compounds bound to the particles are selected to include fully or partially fluorinated alkyl groups or compounds, the particles can display hydrophobicity and oleophobicity.

4.1 Organic and Inorganic HP- and/or HP/OP-Particles and their Composition

HP- and HP/OP-particles having a wide variety of compositions may be employed in the preparation of the articles described herein (e.g., tubing, coatings, and catheters). In some embodiments, the HP- or HP/OP-particles will be particles prepared from precursor particles comprised of inorganic materials including metal oxides (e.g., aluminum oxides such as fumed aluminum oxide, alumina, zinc oxides, nickel oxides, zirconium oxides, iron oxides, and titanium dioxides), oxides of metalloids (e.g., metalloid oxides such as oxides of B, Si, Sb, Te and Ge) including glass, silica (e.g., fumed silica), silicates, aluminosilicates, or particles comprising combinations thereof. In other embodiments, the HP- and HP/OP-particles may comprise, consist essentially of, or consist of one or more organic materials including, but not limited to, polysaccharides (carbohydrates), plastics, thermoplastics, thermoset plastics, polyolefins and/or fluorinated polyolefins. In some embodiments the HP- and HP/OP-particles comprise one or more of polytetrafluoroethylene (PTFE), polyethylene (PE), polypropylene (PP), and polyvinyl fluoride (PVF).

HP- or HP/OP-particles prepared using precursor particles prepared with techniques such as fuming (e.g., fumed silica) and later treated to impart HP or HP/OP behavior, may be comprised of particles sometimes denoted as “primary particles.” As used herein, the term “primary particle size” refers to the size of non-associated particles whose size is typically measured by X-ray Diffraction (XRD), and which have a particle size range typically listed as being from about 1 nm to about 21 nm as measured by XRD. In some instances, such as in the case of fumed silica, the primary particles can be in the range of about 10 nm to about 21 nm, and typically spherical. Primary particles can fuse together to form aggregates from about 21 nm to about 300 nm (about 0.02 microns to about 0.3 microns). Aggregates of some particles, such as fumed silica particles, typically have a mean particle size in the range of about 0.2 to about 0.3 microns (about 200 nm to about 300 nm) as measured by laser diffraction. Aggregates can form larger structures, termed “agglomerates,” that range from about 0.3 microns to about 30 microns as measured by laser diffraction. Depending on the conditions, agglomerates can reach sizes as large as 150 microns as measured by laser diffraction. Large agglomerates can be disrupted by techniques such as sonication to produce agglomerates having a mean particle size less than about 25 or 30 microns by laser diffraction. More vigorous disruption techniques, such as micronization or ball milling, can further reduce particle size, for example reducing agglomerates down to the 1 micron range or approaching the size of aggregates; however, further reductions in size are difficult to achieve. Moreover, even after disruption, agglomerates may reform from aggregates under suitable conditions given sufficient time.

For HP- or HP/OP-particles with a mean diameter below 21 nm, the size is as reported by the manufacturer. For HP- or HP/OP-particles having a size in a range having a lower limit greater than about 21 nm, the mean diameter is determined by laser diffraction, using a MICROTRAC® Bluewave 3000(s), for the particles suspended at 2% by weight in dry acetone. The data may be reported as the mean diameter of the volume distribution (“MV”), the mean diameter of the area distribution (“MA”), or the mean diameter of the number distribution (“MN”) where: MV=ΣVᵢdᵢ/ΣVᵢ; MN=Σ(Vᵢdᵢ²)/Σ(Vᵢdᵢ³); MA=ΣVᵢ/Σ(Vᵢ/dᵢ); and wherein V=volume percent between sizes, and d=size represented by the center between any two sizes for a series of particle measurements. Unless stated otherwise the particle size is understood to be given as the MN. Accordingly, regardless of whether the HP- or HP/OP-particles are prepared from organic or inorganic materials, they will typically have a size in a range selected from the group consisting of: from about 1 nm to about 150 microns (μm), from about 1 nm to about 10 nm, from about 1 nm to about 20 (e.g., 21) nm, from about 1 nm to about 200 nm, from about 1 nm to about 300 nm, from about 10 nm to about 20 (e.g., 21) nm, from about 10 nm to about 200 nm, from about 10 nm to about 300 nm, from about 20 (e.g., 21) nm to about 200 nm, from about 20 (e.g., 21) nm to about 300 nm, from 21 nm to about 150 microns, from about 50 nm to about 300 nm, from about 100 nm to about 1 micron, from about 200 nm to about 500 nm, from about 200 nm to about 60 microns, from about 250 nm to about 1.0 μm, from about 500 nm to about 2.5 μm, from about 1.0 μm to about 10.0 μm, from about 1 μm to about 20 μm, from about 1 μm to about 40 μm, from about 5 μm to about 20 μm, from about 5 μm to about 50 μm, from about 10 μm to about 100 μm, from about 20 μm to about 50 μm, from about 20 μm to about 100 μm, from about 25 μm to about 35 μm, from about 25 μm to about 50 μm, from about 25 μm to about 75 μm, from about 30 μm to about 50 μm, from about 30 μm to about 75 μm, from about 30 μm to about 100 μm, from about 40 μm to about 60 μm, from about 40 μm to about 100 μm, from about 50 μm to about 80 μm, from about 75 μm to about 100 μm, from about 75 μm to about 125 μm, from about 75 μm to about 130 μm, from about 100 μm to about 125 μm, and from about 100 μm to about 150 μm. Such particles may have a surface area in a range selected from the group consisting of about 50 to about 400, about 50 to about 100, about 50 to about 250, about 100 to about 250, about 250 to about 300, about 280 to about 330, about 300 to about 380, about 250 to about 400, and greater than about 400 m²/g.

The measurement of particle size by laser diffraction scattering may be further characterized by the “width” of the measurement denoted (“SD”), which is not to be confused with the standard deviation that is an indication of variability for multiple measurements. The width is calculated as (84%-16%)/2 of the particle distribution when measurements are conducted on the MICROTRAC Bluewave instrument. In one set of embodiments, the HP- or HP/OP-particles have an MV value in a range selected from the group consisting of from about 25 μm to about 35 μm, from about 25 μm to about 50 μm, and from about 25 μm to about 75 μm, and the width (SD) of the measurement is less than about 24, 22, 20, 18, 16, 14, 12, or 10 microns. In another embodiment, the HP or HP/OP particles have an MV value in a range selected from the group consisting of from about 30 μm to about 50 μm, from about 30 μm to about 75 μm, and from about 30 μm to about 100 μm, and the width (SD) of the measurement is less than about 28, 26, 24, 22, 20, 18, 16, or 14 microns. In another embodiment, the HP or HP/OP particles have an MV value in a range selected from the group consisting of from about 40 μm to about 60 μm, from about 40 μm to about 100 μm, from about 50 μm to about 80 μm, from about 60 μm to about 80 μm, from about 75 μm to about 100 μm, from about 75 μm to about 125 μm, from about 75 μm to about 130 μm, from about 100 μm to about 125 μm, and from about 100 μm to about 150 μm where the width (SD) of the measurement is less than about 38, 36, 34, 32, 30, 28, 26, 24, 22, 20, 18, or 16 microns.

HP- and HP/OP-particles may be further characterized as having a lower diameter limit where greater than 90%, 95%, 98%, or 99% of the particles have an MV, MA or MN greater than the lower diameter limit. Those lower diameter limits are also termed the 10%, 5%, 2% and 1% lower diameter cutoff limits, respectively. Accordingly, in one set of embodiments the HP- or HP/OP-particles have an MV value in a range selected from about 20 μm to about 30 μm, wherein the particles have a 1% lower diameter cutoff less than 8, 9, 10, or 11 microns, and/or a 10% lower diameter cutoff less than 14, 15, 16, or 17 microns. In another set of embodiments, the particles have an MV value in a range selected from about 30 μm to about 40 μm, wherein the particles have a 1% lower diameter cutoff less than 10, 11, 12, 13, or 14 microns, and/or a 10% lower diameter cutoff less than 20, 21, 22, or 23 microns. In another set of embodiments, the particles have an MV value in a range selected from about 40 μm to about 50 μm, wherein the particles have a 1% lower diameter cutoff less than 11, 12, 13, 14, or 15 microns, and/or a 10% lower diameter cutoff less than 21, 22, 23, or 24 microns. In another set of embodiments, the particles have an MV value in a range selected from about 50 μm to about 60 μm, wherein the particles have a 1% lower diameter cutoff less than 13, 14, 15, or 16 microns, and/or a 10% lower diameter cutoff less than 24, 25, 26, or 27 microns. In another set of embodiments, the particles have an MV value in a range selected from about 60 μm to about 80 μm, wherein the particles have a 1% lower diameter cutoff less than 13, 14, 15, or 16 microns, and/or a 10% lower diameter cutoff less than 24, 25, 26, or 27 microns. In each embodiment the values are determined by laser diffraction analysis of a 2% suspension of the particles in acetone (by weight) employing a MICROTRAC Bluewave S-3000 instrument.

HP- and HP/OP-particles in any of the size ranges recited above may have a surface area in a range (expressed in m²/g) selected from the group consisting of about 50 to about 400, about 50 to about 100, about 50 to about 250, about 100 to about 250, about 250 to about 300, about 280 to about 330, about 300 to about 380, about 250 to about 400, and greater than about 400 m²/g. Unless stated otherwise, the surface area of HP- and HP/OP-particles is understood to be BET (Brunauer, Emmett and Teller) surface area determined by DIN ISO 9277:2014-01, entitled “Determination of the specific surface area of solids by gas adsorption—BET method.”

The hydrophobic or superhydrophobic particles, spread on a substantially planar surface in the absence of any binder, may have a contact angle with water at room temperature greater than about 90°, 100°, 110°, 120°, 130°, 135°, 140°, 145°, 150°, 155°, 160°, 165°, 170° or 175° degrees, or in a range selected from the group consisting of about 90°-110°, 100°-130°, 120°-135°, 130°-155°, 140°-160°, 155°-170°, and 165°-175°. In some embodiments, the particles have been treated with a compound of formula (I) (below) that comprises one or more halogen atoms in their R groups; in some embodiments the halogen atoms are fluorine atoms. In such embodiments the contact angle of water with the particles at room temperature is greater than about 140°, 145°, 150°, 155°, 160°, 165°, 170° or 175°, or in a range selected from the group consisting of about 140°-160°, 155°-170°, and 165°-175°. The contact angle of the particles absent the binder can be determined by spraying a thin coating of particles on a substantially planar surface and making a measure of the static contact angle with a goniometer (e.g., Attension Model Theta goniometer, formerly KSV Instruments, available from BIOLIN SCIENTIFIC, Stockholm, Sweden).

In some embodiments, the HP- or HP/OP-particles employed herein have the characteristics set forth in Table 2.

TABLE 2
Select HP- or HP/OP-Particle Embodiments based on Silica, Alumina, Metal
Oxide or Metalloid Oxides and covalently or non-covalently bound groups or moieties to
enhance HP or HP/OP properties

| | Particle Size | | | |
|---|---|---|---|---|
| Property | MV, MN or | BET Surface Area | Contact Angle | |
| Number | MA (microns) | (m^{2/}g) | with Water† | (Particle modified with) |
| 1 | about 1 | about 50 to about 400, | 100° to 120°, | Compound of Formula (I) |
| | to | about 60 to about 100, | 100° to 130°, | |
| | about 150 | about 70 to about 250, | 120° to 135°, | |
| | | about 100 to about 260, | 130° to 155°, | |
| | | about 170 to about 300, | 140° to 160°, | |
| | | about 250 to about 350, | 155° to 170°, | |
| | | about 250 to about 400, or | 165° to 175° or | |
| | | about 330 to about 400 | 150° to 180° | |
| 2 | about 1 | about 50 to about 400, | 100° to 120°, | A siloxane |
| | to | about 60 to about 100, or | 100° to 130°, | (e.g., polydimethyl siloxane) |
| | about 150 | about 70 to about 250, | 120° to 135°, | |
| | | | 130° to 155°, | |
| | | | 140° to 160°, | |
| | | | 155° to 170° or | |
| | | | 165° to 175° | |
| 3 | about 1 | about 50 to about 400, | 100° to 120°, | A silizane |
| | to | about 60 to about 100, | 100° to 130°, | (e.g., hexamethyldisilazane) |
| | about 150 | about 70 to about 250, | 120° to 135°, | |
| | | about 100 to about 260, or | 130° to 155°, | |
| | | about 170 to about 300 | 140° to 160°, | |
| | | | 155° to 170° or | |
| | | | 165° to 175° | |
| 4 | about 10 | about 70 to about 120, | 100° to 120°, | Compound of Formula (I) |
| | to | about 100 to about 200, | 120° to 130°, | |
| | about 25 | about 180 to about 320, | 130° to 140°, | |
| | | about 250 to about 350, | 140° to 160°, | |
| | | about 250 to about 400, or | 160° to 170° or | |
| | | about 330 to about 400 | 170° to 180° | |
| 5 | about 20 | about 180 to about 320, | 130° to 140°, | Compound of Formula (I) |
| | to | about 250 to about 350, | 140° to 160°, | where R is a linear or |
| | about 80 | about 250 to about 400, or | 160° to 170° or | branched alkyl or fluoroalkyl |
| | | about 330 to about 400 | 170° to 180° | group having from 6 to 8, 6 to |
| | | | | 9, 6 to 10, 6 to 20, 8 to 12, 8 to |
| | | | | 20, 10 to 16, or 12 to 20 |
| | | | | carbon atoms |
| 6 | about 25 | about 70 to about 120, | 130° to 140°, | Compound of Formula (I) |
| | to | about 100 to about 200, | 140° to 160°, | where R is a linear or |
| | about 60 | about 180 to about 320, | 160° to 170° or | branched alkyl or fluoroalkyl |
| | | about 250 to about 350, | 170° to 180° | group having from 6 to 8, 6 to |
| | | about 250 to about 400, or | | 9, 6 to 10, 6 to 20, 8 to 12, 8 to |
| | | about 330 to about 400 | | 20, 10 to 16, or 12 to 20 |
| | | | | carbon atoms. |
| 7 | about 30 | about 70 to about 120, | 130° to 140°, | Compound of Formula (I) |
| | to | about 100 to about 200, | 140° to 160°, | where R is a linear or |
| | about 75 | about 180 to about 320, | 160° to 170° or | branched alkyl or fluoroalkyl |
| | | about 250 to about 350, | 170° to 180° | group having from 6 to 8, 6 to |
| | | about 250 to about 400, or | | 9, 6 to 10, 6 to 20, 8 to 12, 8 to |
| | | about 330 to about 400 | | 20, 10 to 16, or 12 to 20 |
| | | | | carbon atoms |
| 8 | about 40 | about 70 to about 120, | 130° to 140°, | Compound of Formula (I) |
| | to | about 100 to about 200, | 140° to 160°, | where R is a linear or |
| | about 80 | about 180 to about 320, | 160° to 170° or | branched alkyl or fluoroalkyl |
| | | about 250 to about 350, | 170° to 180° | group having from 6 to 8, 6 to |
| | | about 250 to about 400, or | | 9, 6 to 10, 6 to 20, 8 to 12, 8 to |
| | | about 330 to about 400 | | 20, 10 to 16, or 12 to 20 |
| | | | | carbon atoms |
| 9 | about 50 | about 70 to about 120, | 130° to 140°, | Compound of Formula (I) |
| | to | about 100 to about 200, | 140° to 160°, | where R is a linear or |
| | about 100 | about 180 to about 320, | 160° to 170° or | branched alkyl or fluoroalkyl |
| | | about 250 to about 350, | 170° to 180° | group having from 6 to 8, 6 to |
| | | about 250 to about 400, or | | 9, 6 to 10, 6 to 20, 8 to 12, 8 to |
| | | about 330 to about 400 | | 20, 10 to 16, or 12 to 20 |
| | | | | carbon atoms and/or an olefin |
| | | | | (e.g., vinyl) group |
| 10 | about 75 | about 70 to about 120, | 130° to 140°, | Compound of Formula (I) |
| | to | about 100 to about 200, | 140° to 160°, | where R is a linear or |
| | about 125 | about 180 to about 320, | 160° to 170° or | branched alkyl or fluoroalkyl |
| | | about 250 to about 350, | 170° to 180° | group having from 6 to 8, 6 to |
| | | about 250 to about 400, or | | 9, 6 to 10, 6 to 20, 8 to 12, 8 to |
| | | about 330 to about 400 | | 20, 10 to 16, or 12 to 20 |
| | | | | carbon atoms and/or an olefin |
| | | | | (e.g., vinyl) group |
| 11 | about 100 | about 70 to about 120, | 130° to 140°, | Compound of Formula (I) |
| | to | about 100 to about 200, | 140° to 160°, | where R is a linear or |
| | about 150 | about 180 to about 320, | 160° to 170°, or | branched alkyl or fluoroalkyl |
| | | about 250 to about 350, | 170° to 180° | group having from 6 to 8, 6 to |
| | | about 250 to about 400, or | | 9, 6 to 10, 6 to 20, 8 to 12, 8 to |
| | | about 330 to about 400 | | 20, 10 to 16, or 12 to 20 |
| | | | | carbon atoms and/or an olefin |
| | | | | (e.g., vinyl) group |
| 12 | about 120 | about 70 to about 120, | 130° to 140°, | Compound of Formula (I) |
| | to | about 100 to about 200, | 140° to 160°, | where R is a linear or |
| | about 150 | about 180 to about 320, | 160° to 170°, or | branched alkyl or fluoroalkyl |
| | | about 250 to about 350, | 170° to 180° | group having from 6 to 8, 6 to |
| | | about 250 to about 400, or | | 9, 6 to 10, 6 to 20, 8 to 12, 8 to |
| | | about 330 to about 400 | | 20, 10 to 16, or 12 to 20 |
| | | | | carbon atoms and/or an olefin |
| | | | | (e.g., vinyl) group |

†Determined by spraying particles suspended in acetone on planar surface. The contact angle is measured on the particles after the acetone has evaporated.

4.2 Incorporation of Hydrophobic Groups or Moieties

As indicated above, organic or inorganic particles that do not display sufficient HP or HP/OP characteristics (precursor particles) may be treated to introduce one or more groups or moieties that may be covalently or non-covalently bound to the particles to enhance the HP or HP/OP properties. The groups or moieties impart HP or HP/OP properties to the particles and can be introduced into the particles prior to employing them in the methods and articles described herein. In some embodiments, the particles are treated with a siloxane (e.g., PDMS) or a silazane (e.g., hexamethyldisilizane) to introduce HP/OP properties to the particles, in addition to any such properties already possessed by the particles. PDMS may be covalently or non-covalently bound to the particles. In other embodiments, the particles are treated with a silanizing agent to introduce HP or HP/OP properties to the particles in addition to any such properties already possessed by the particles.

In embodiments where a silanizing agent is employed, the silanizing agent may be a compound of the formula (I) or a mixture of two, three or more compounds of formula (I):

R₄₋ₙSi—Xₙ (I)

where n is an integer selected from 1, 2, or 3;
each R is independently selected from
   (i) alkyl or cycloalkyl group optionally substituted with one or more fluorine atoms,
   (ii) C_{1 to 20} alkyl optionally substituted with one or more substituents independently selected from fluorine atoms and C_{6 to 14} aryl groups, which aryl groups are optionally substituted with one or more independently selected halo, C_{1 to 10} alkyl, C_{1 to 10} haloalkyl, C_{1 to 10} alkoxy, or C_{1 to 10} haloalkoxy substituents,
   (iii) C_{2 to 8} or C_{6 to 20} alkyl ether optionally substituted with one or more substituents independently selected from fluorine and C_{6 to 14} aryl groups, which aryl groups are optionally substituted with one or more independently selected halo, C_{1 to 10} alkyl, C_{1 to 10} haloalkyl, C_{1 to 10} alkoxy, or C_{1 to 10} haloalkoxy substituents,
   (iv) C_{6 to 14} aryl, optionally substituted with one or more substituents independently selected from halo, alkoxy, or haloalkoxy substituents,
   (v) C_{2 to 20} alkenyl or C_{2 to 20} alkynyl, optionally substituted with one or more substituents independently selected from halo, alkoxy, or haloalkoxy, and
   (vi) —Z—((CF₂)_{q}(CF₃))ᵣ, wherein Z is a C_{1 to 12} or a C_{2 to 8} divalent alkane radical or a C_{2 to 12} divalent alkene or alkyne radical, q is an integer from 1 to 12, and r is an integer from 1 to 4;
   each X is independently selected from —H, —Cl, —I, —Br, —OH, —OR², —NHR³, or —N(R³)₂;
   each R² is an independently selected C_{1 to 4} alkyl or C_{1 to 4} haloalkyl group; and
   each R³ is an independently selected H, C_{1 to 4} alkyl, or C_{1 to 4} haloalkyl group;
wherein
   each C_{1 to 4} alkyl or haloalkyl group is independently selected to comprise 1, 2, 3, or 4 carbon atoms and may be linear or branched,
   each C_{2 to 8} alkyl group is independently selected to comprise 2, 3, 4, 5, 6, 7, or 8 carbon atoms and may be linear or branched,
   each C_{6 to 20} alkyl group is independently selected to comprise 6, 7, 8, 9, 10, 11, 12, 13, 14, 15, 16, 17, 18, 19, or 20 carbon atoms and may be linear or branched,
   each C_{1 to 10} alkyl, haloalkyl, alkoxy, haloalkoxy, or haloalkyl group is independently selected to comprise 1, 2, 3, 4, 5, 6, 7, 8, 9, or 10 carbon atoms and may be linear or branched, and
   each C_{1 to 20} alkyl or cycloalkyl group is independently selected to comprise 1, 2, 3, 4, 5, 6, 7, 8, 9, 10, 11, 12, 13, 14, 15, 16, 17, 18, 19, or 20 carbon atoms and may be linear or branched.

In some embodiments, each R is an independently selected linear or branched alkyl or fluoroalkyl group having from 6 to 8, 6 to 9, 6 to 10, 6 to 20, 8 to 10, 8 to 12, 8 to 20, 10 to 12, 10 to 16, or 10 to 20 carbon atoms.

In some embodiments, each R is an independently selected linear or branched alkyl or fluoroalkyl group having from 6 to 8, 6 to 9, 6 to 10, 6 to 20, 8 to 10, 8 to 12, 8 to 20, 10 to 12, 10 to 16, or 10 to 20 carbon atoms and n is 3.

In some embodiments, each R is independently selected and has the formula —Z—((CF₂)_{q}(CF₃))ᵣ, wherein Z is a divalent linear or branched alkane radical having 1, 2, 3, 4, 5, 6, 7, 8, 9, 10, 11, or 12 carbon atoms (e.g., in a range selected from 1-4, 5-8, 1-3, 3-6, 7-9, and 9-12), each q is an integer selected from 1, 2, 3, 4, 5, 6, 7, 8, 9, 10, 11, or 12 (e.g., in a range selected from 1-4, 5-8, 1-3, 3-6, 7-9, and 9-12), and each r is an integer selected from 1, 2, 3, or 4. In other embodiments, Z is a divalent linear or branched alkene or alkyne radical having 2, 3, 4, 5, 6, 7, 8, 9, 10, 11, or 12 carbon atoms (e.g., in a range selected from 2-4, 5-8, 2-3, 3-6, 7-9, and 9-12), q is an integer selected from 1, 2, 3, 4, 5, 6, 7, 8, 9, 10, 11, or 12 (e.g., in a range selected from 1-4, 5-8, 1-3, 3-6, 7-9, and 9-12), and r is an integer selected from 1, 2, 3, or 4.

In some embodiments where covalent attachment of the HP- or HP/OP-particles to the silicone components is desired, the compound(s) of formula (I) used to modify the particles may include one or more C_{2 to 20} alkenyl or alkynyl moieties that are selected independently (e.g., C_{2 to 4}, C_{2 to 6}, C_{2 to 8}, C_{4 to 8}, C_{4 to 12}, C_{8 to 12}, C_{8 to 16}, or C_{12 to 20} alkenyl or alkynyl).

In any of the previously mentioned embodiments of compounds of formula (I), the value of n may be varied such that 1, 2 or 3 independently selected R groups are present. Thus, in some embodiments, n is 3. In other embodiments, n is 2. In still other embodiments, n is 1.

In any of the previously mentioned embodiments of compounds of formula (I), all halogen atoms present in any one or more R groups may be fluorine.

In any of the previously mentioned embodiments of compounds of formula (I), X may be independently selected from —H, —Cl, —OR², —NHR³, —N(R³)₂, or combinations thereof. In other embodiments, X may be selected from —Cl, —OR², —NHR³, —N(R³)₂, or combinations thereof. In still other embodiments, X may be selected from —Cl, —NHR³, —N(R³)₂, or combinations thereof.

Any tubing or coating applied to tubing described herein may be prepared with one, two, three, four or more compounds of formula (I) employed alone or in combination to modify the precursor particles. The use of silanizing agents of formula (I) to modify precursor particles will introduce one or more R₃₋ᵥXᵥSi— groups where v is 0, 1, or 2 (e.g., R₃Si—, R₂X₁Si—, or RX₂Si— groups) where R and X are as defined for a compound of formula (I). The value of v is 0, 1, or 2, due to the displacement of at least one “X” substituent and formation of at least one bond between the particle and the Si atom (the bond between the particle and the silicon atom is indicated by a dash “—”. It will be understood that more than one X can be displaced to form bonds, and accordingly, in addition to those groups recited above, groups including R₂Si═, RX₁Si═, or RSi≡ groups, may be bound to the particles where “═” and “≡” denote the displacement of two or three groups, respectively, with the formation of at least one bond to the particles.

In some embodiments, HP- or HP/OP-particles are comprised of silica, silicates, alumina (e.g., Al₂O₃), titanium oxide, zinc oxide, and/or cerium oxide treated with one or more silanizing agents, e.g., compounds of formula (I). In other embodiments, HP- or HP/OP-particles are comprised of silica, silicates, alumina, titanium oxide, or zinc oxide treated with a siloxane (e.g., polydimethylsiloxane, PDMS). In other embodiments, the HP- or HP/OP-particles are silica, silicates, glass, alumina, titanium oxide, or zinc oxide, treated with a silanizing agent, a siloxane or a silazane (hexamethyldisilazane). In other embodiments, the HP- or HP/OP-particles may be a fumed metal or metalloid (e.g., particles of fumed silica or fumed zinc oxide) treated with a silanizing agent, a siloxane or a silazane (hexamethyldisilazane).

Suitable silanizing agents for modifying the precursor particles to produce HP- or HP/OP-particle-containing compositions may comprise alkyl groups (hydrocarbon containing groups) or fluorinated or polyfluorinated alkyl groups (e.g., fluoroalkyl groups) including, but not limited to:
(tridecafluoro-1,1,2,2-tetrahydrooctyl)silane (SIT8173.0);
(tridecafluoro-1,1,2,2-tetrahydrooctyl)trichlorosilane (SIT8174.0);
(tridecafluoro-1,1,2,2-tetrahydrooctyetriethoxysilane (SIT8175.0);
(tridecafluoro-1,1,2,2-tetrahydrooctyl)trimethoxysilane (SIT8176.0);
(heptadecafluoro-1,1,2,2-tetrahydrodecyl)dimethyl(dimethylamino)silane (SIH5840.5);
(heptadecafluoro-1,1,2,2-tetrahydrodecyl)tris(dimethylamino)silane (SIH5841.7);
n-octadecyltrimethoxysilane (SIO6645.0); n-octyltriethoxysilane (SIO6715.0); and
3,3,4,4,5,5,6,6,6-nonafluorohexyldimethyl(dimethylamino)silane (SIN6597.4)
   where the designations given in parentheses are the product numbers from Gelest, Inc., Morrisville, Pa. In addition to bearing fluorinated alkyl groups, such particles may also comprise olefin (e.g., vinyl) groups incorporated by reaction with compounds such as vinyl trimethoxy silane or vinyl triethoxy silane.

Another group of reagents that can be employed to modify precursor particles and prepare HP- or HP/OP-particles includes:
(tridecafluoro-1,1,2,2-tetrahydrooctyl)trichlorosilane;
(tridecafluoro-1,1,2,2-tetrahydrooctyl)triethoxysilane;
nonafluorohexyldimethylchlorosilane;
(tridecafluoro-1,1,2,2-tetrahydrooctyl)trimethoxysilane;
3,3,4,4,5,5,6,6,6-nonafluorohexyldimethyl(dimethylamino)-silane;
nonafluorohexylmethyldichlorosilane;
nonafluorohexyltrichlorosilane;
nonafluorohexyltriethoxysilane; and
nonafluorohexyltrimethoxysilane.

In addition to the silanizing agents recited above, a variety of other agents can be used to alter the properties of precursor particles and to introduce hydrophobic and/or oleophobic properties. In some embodiments, precursor particles (e.g., fumed silica particles) may be treated with one or more agents selected from dimethyldichlorosilane, hexamethyldisilazane, octyltrimethoxysilane, vinyl trimethoxy silane, vinyl triethoxy silane, and tridecafluoro-1,1,2,2-tetrahydrooctyl trichlorosilane. In some embodiments, the resulting HP- or HP/OP-particles may have an average size in a range selected from about 1 nm to about 50 nm, from about 1 nm to about 100 nm, from about 1 nm to about 400 nm, from about 1 nm to about 500 nm, from about 2 nm to about 120 nm, from about 5 nm to about 150 nm, from about 5 nm to about 400 nm, from about 10 nm to about 300 nm, from about 20 nm to about 400 nm, or from about 50 nm to about 250 nm.

Other agents that can be used to modify precursor particles to impart hydrophobic properties to the particles include, but are not limited to, one or more of: siloxanes (e.g., polydimethylsiloxane or methyl alkyl siloxanes), gamma-aminopropyltriethoxysilane, DYNASYLAN® A (tetraethylorthosilicate), hexamethyldisilazane, and DYNASYLAN® F 8263 (fluoroalkylsilane), any one or more of which may be used alone or in combination with any of the silanizing agents recited herein.

Two attributes of silanizing agents that may be considered for the purposes of their reaction with precursor particles and the introduction of hydrophobic or oleophobic moieties are the leaving group (e.g., X groups of compounds of formula (I)) and the terminal functionality (i.e. the R groups of compounds of formula (I)). A silanizing agent's leaving group(s) can determine the reactivity of the agent with the hydrophobic particle(s), or other components of the coating, if applied after a coating has been applied. Where the HP- or HP/OP-particles are a silicate or silica (e.g., fumed silica), the leaving group can be displaced to form Si—O—Si bonds. Leaving group effectiveness is ranked in decreasing order as chloro>methoxy>hydro (H)>ethoxy (measured as trichloro>trimethoxy>trihydro>triethoxy). This ranking of the leaving groups is consistent with their bond dissociation energy. The terminal functionality generally determines the level of hydrophobicity and oleophobicity that results from the presence of the silane.

4.3 Some Commercially Available HP- or HP/OP-Particles

HP- or HP/OP-particles, such as those comprising fumed silica, may be purchased from a variety of suppliers including, but not limited to, Cabot Corp., Billerica, Mass. (e.g., Nanogel TLD201, CAB—O-SIL® TS-720 (silica, pretreated with polydimethylsiloxane), and M5 (untreated silica)) and Evonik Industries, Essen, Germany (e.g., ACEMATT® silica such as untreated HK400, AEROXIDE® silica, AEROXIDE® TiO₂ titanium dioxide, and AEROXIDE® Alu alumina).

Some commercially available HP- or HP/OP-particles are set forth in Table 8 along with their surface treatment by a silanizing agent or polydimethylsiloxane.

TABLE 3
Some commercially available precursor particles and HP or HP/OP particles

| | | | | | |
|---|---|---|---|---|---|
| | | | Nominal | | |
| | | | BET Surface | | |
| | | | Area of Base | Primary | |
| Product | Surface | Level of | Product | Particle | Product |
| Name | Treatment | Treatment | (m²/g) | Size (nm) | Source |

Precursor Particles

| | | | | | |
|---|---|---|---|---|---|
| M-5 | None | None | 200 | — | Cab-O-Sil |
| Aerosil ® | None | None | 200 | 12 | Evonik |
| 200 | | | | | |
| Aerosil ® | None | None | 255 | — | Evonik |
| 255 | | | | | |
| Aerosil ® | None | None | 300 | 7 | Evonik |
| 300 | | | | | |
| Aerosil ® | None | None | 380 | 7 | Evonik |
| 380 | | | | | |
| HP-60 | None | None | 200 | — | Cab-O-Sil |
| PTG | None | None | 200 | — | Cab-O-Sil |
| H-5 | None | None | 300 | — | Cab-O-Sil |
| HS-5 | None | None | 325 | — | Cab-O-Sil |
| EH-5 | None | None | 385 | — | Cab-O-Sil |

Hydrophobic/Superhydrophobic HP or HP/OP Particles

| | | | | | |
|---|---|---|---|---|---|
| TS-610 | Dimethyldichloro- | Intermediate | 130 | — | Cab-O-Sil |
| | silane | | | | |
| TS-530 | Hexamethyldisilazane | High | 320 | — | Cab-O-Sil |
| TS-382 | Octyltrimethoxysilane | High | 200 | — | Cab-O-Sil |
| TS-720 | Polydimethylsiloxane | High | 200 | — | Cab-O-Sil |
| Aerosil ® | Polydimethylsiloxane | — | 100 | 14 | Evonik |
| R202 | | | | | |
| Aerosil ® | Hexamethyldisilazane | — | 125-175 | — | Evonik |
| R504 | (HMDS) and | | | | |
| | aminosilane | | | | |
| Aerosil ® | HMDS based on | — | 220 | — | Evonik |
| R812S | Aerosil ® 300 | | | | |
| Aeroxide ® | n-octyl-silane on | Carbon | 85-115 | — | Evonik |
| Alu | Alumina | content 3.0-4.5% | | | |
| C 805 | | | | | |

BET Surface Area is Brunauer, Emmett and Teller surface area

As purchased, the untreated precursor particles (e.g., M5 silica) may not possess any HP/OP properties. Such untreated particles can be treated to covalently attach one or more groups or moieties to the particles that give them HP/OP properties, for example, by treatment with the silanizing agents discussed above. Regardless of whether the particles are untreated (precursor particles) or already treated to provide HP or HP/OP properties, the particles may be treated with silanes that permit the covalent attachment of the particles to the siloxane polymers as they cure. In one embodiment the olefin containing silanes that permit the covalent attachment of the particles to the polymer during hydrosilylation reactions. In one such embodiment the olefins comprise vinyl groups (e.g., such as vinyl trimethoxy silane or vinyl triethoxy silane). In an embodiment, the particles are treated with one or more or two more compounds of formula (I), such that the particles comprise at least one type of olefin (e.g., vinyl) group and alkyl and/or fluoroalkyl groups, each of which are covalently attached. In another embodiment the particles comprise an alkyl siloxane (PDMS or PDES) bound either covalently or non-covalently and a covalently bound olefin (e.g., vinyl) group). In another embodiment polymer initiator e.g., 3-trimethyloxysilyl)propyl 2-bromo-2-methylpropionate available from Gelest as product SIT8397 is covalently conjugated to particle surface and further reacted with methacrylate or acrylate monomers to yield polymer grafted particles.

### 5.0 Forming Articles

As discussed above, the articles, which include coatings, described herein can be prepared by curing (polymerizing) a composition comprising polymerizable monomers, functionalized oligomers, and/or functionalized polymers, where the functionalization permits bonds to be formed between the monomers, oligomers, and/or polymers. The articles include a first lubricating fluid that is either mixed with monomers, oligomers, and/or polymers during polymerization or applied to the article after polymerization. The articles may also include a second lubricating fluid that can be applied to the articles following application of the first lubricating fluid.

In one embodiment, the articles described herein may comprise a first lubricating fluid (comprising one or more lubricating fluids) that is distributed throughout a polymer composition used to form all or part of an article. Distributing lubricating fluids in, and even uniformly (or non-uniformly) throughout, the polymer composition may be accomplished by contacting the polymer component of the article, or the entire article, with the lubricating fluid(s) and allowing the fluids to permeate the polymer. Heat, pressure/reduced pressure (partial vacuum), and/or carrier solvents may be utilized to assist in introducing the fluid into the polymer. Where carrier solvents are utilized, those that cause the polymer to swell and which are volatile enough to be removed using heat and/or reduced pressure (e.g., partial vacuum) may be most beneficial. Alternatively, the first lubricating fluid(s) may be distributed throughout a polymer composition used to form all or part of an article by mixing the fluid(s) with the uncured (unpolymerized) components used to prepare the article. In such a method of forming an internally lubricated article or part thereof, fluid(s) are distributed throughout the article by: i) combining polymerizable monomers, functionalized oligomers, and/or functionalized polymers, which can be polymerized to prepare silicone elastomers, with a first lubricating fluid (e.g., a mix of one or more lubricating fluids) to form an internally lubricated pre-polymer composition; and ii) curing the internally lubricated pre-polymer composition by polymerizing the monomers, functionalized oligomers, and/or functionalized polymers to form a cured article or cured part of an article.

The type of curing reaction (light, heat, moisture, etc.) and the properties of the pre-polymer composition (e.g., viscosity, rate of polymerization) will affect the type of processes that may be used to form (shape) articles from the compositions described herein. The compositions may be formed by molding in open molds, casting (e.g. spin casting), extrusion, or coating on material such as by dipping, spraying, painting and the like. Depending on the curing rate, initiation of the polymerization reaction may be started before the material is shaped into its final form or prior to forming (e.g., pouring into a form or a casting in a mold).

In embodiments where particles (e.g., inorganic HP-particles displaying either HP or HP/OP properties or precursors thereto) are added to pre-polymer compositions, the particles may be present from about 0.1% to about 85% by weight of the composition based upon the weight of the all particles and the polymerizable components (curable monomers, oligomers, and functionalized polymers that can be covalently linked during curing). In such embodiments the particles may comprise from about 0.1 to about 5%, from about 0.5 to about 10%, from about 10% to about 20%, from about 10% to about 50%, from about 20% to about 40%, from about 40% to about 60%, from about 50 to about 85%, or from about 60 to about 85% particles.

In embodiments where the particles (HP-particles or precursors thereto) do not comprise groups that permit them to be covalently linked to the silicone (siloxane) elastomer, the particles are typically present in less than 30% by weight, with or without up to about 55% by weight of particles (HP-particles or precursors thereto) that can be covalently linked to the silicone (siloxane) elastomer during curing, where the weight percent is based on the weight of the curable components and particles as combined. Accordingly, in some embodiments the compositions may comprise from 0.1%-55% (e.g., 0.1-5%, 0.1%-20%, 5%-10%, 10%-20%, 20%-40%, 20%-55%, or 40%-55%) by weight of particles (HP-particles or precursor thereto) that can be covalently linked to the siloxane during curing, with the remainder of the particles present not covalently attached to the siloxane. In an embodiment, the compositions may comprise 0%-100% (e.g., 0%-5%, 5%-10%, 5%-20%, 10%-20%, 10%-30%, 30%-45%, 45%-60%, 45%-99%, 60%-75%, 75%-95%, 95%-99% or 95%-100%) by weight of particles (HP-particles or precursor thereto) that do not become covalently bound to the siloxane during curing.

In those embodiments where HP-particles are employed, such as to prepare articles (e.g., tubing, shunts, ports (central lines) and catheters, coatings, etc.), the articles can have a greater number of HP- or HP/OP-particles on, adjacent to and/or at the exposed surface, where they can interact with liquids contacted with the polymer composition, compared to the amount of HP-particles in the central region of the material prepared with the siloxane polymer compositions described herein. The localization of increased amounts of HP- or HP/OP-particles to one or more surfaces of an article may be accomplished when forming the article either by: (i) application of compositions comprising HP-particles (a top coat) to formed articles (prior to curing); or (ii) application of a layer of a composition comprising HP- or HP/OP-particles and the components necessary to cause formation of siloxane elastomer over a formed article (e.g., as an inner or outer layer or coating on all or part of an article's surface). Where HP-particles are applied as a top coat to articles prior to curing they may be applied using a stream of gas, first lubricating fluid, and/or compatible solvent which is volatile under ambient or curing conditions.

Following curing either in the presence of a first lubricating fluid, or the subsequent addition of a first lubricating fluid to a cured material, the internally lubricated material/article may be treated with a second lubricating fluid (comprising one or more lubricating fluids) by applying a second lubricating fluid to all or part of the surface of the cured article. The second fluid may be applied to the article undiluted or mixed with a compatible carrier solvent. As discussed above for the application of first lubricating fluids, where carrier solvents are utilized, those that cause the polymer to swell and which are volatile enough to be removed using heat and/or reduced pressure (e.g., partial vacuum) may be most beneficial. Carrier solvents include cyclic siloxanes (e.g., D4, D5, D6 and/or combinations of those cyclic siloxanes).

The process of forming articles from the compositions described herein may substantively affect the performance of those articles. The articles may be non-porous even though they comprise substantial amounts of lubricating fluids. In addition, in some embodiments the equipment (molding, casting, coating, extruding equipment etc.) that is used to shape articles may be designed to impart a smooth finish or to provide a texture or pattern (e.g., a micro-texture or micro-pattern) into the surface. Surface texture may also be imparted to the surface of an article by chemical means (e.g., etching), by mechanical means (e.g., abrasion, such as with wires or other metal objects, or sand blasting), or by imparting a pattern in the article by applying a micro-textured surface. For example, a textured roller or plate (textured platen) may be heated and pressed against all or part of an article's surface, or against a heat curable composition so that the composition cures sufficiently to accept the surface texture. Similarly, texture may be imparted by the application of a roller or plate in conjunction with light. In one such embodiment a textured roller or plate transparent to the frequency of light (e.g., UV and/or Vis) applied is employed with an illumination source.

In some embodiments the surface(s) of articles (e.g., coatings) may be relatively smooth, having an arithmetical mean roughness less than about 15, 10, 5, 4, 3, 2, 1, or 0.5 microns. In other embodiments, the micro-texture or micro-pattern promotes hydrophobic behavior by encouraging Cassie-type interactions of certain liquids with the surface while helping to retain any second lubricating fluid that may be applied to the article. In some embodiments, articles may have a micro-pattern or micro-texture with an arithmetical mean roughness in a range selected from about 15 microns to about 500 microns (e.g., about 15 microns to about 35 microns, about 25 microns to about 75 microns, about 50 microns to about 100 microns, about 75 microns to about 100 microns, about 75 microns to about 150 microns, about 100 microns to about 150 microns, about 100 microns to about 200 microns, about 125 microns to about 175 microns, about 150 microns to about 200 microns, about 175 microns to about 250 microns, about 200 microns to about 250 microns, about 200 microns to about 300 microns, about 225 microns to about 300 microns, about 250 microns to about 350 microns, about 300 microns to about 400 microns, about 350 microns to about 450 microns, or about 400 microns to about 500 microns).

Where the pre-polymer composition used to form the articles described herein comprises chemical groups or precursors of HP-particles that can be modified by reaction with silanizing agents (e.g., compounds of formula (I)), such silanizing agents may be used to render the polymer composition more hydrophobic/oleophobic. Depending on the nature of the polymer, the types of precursor particles that may be present, the reactivity of the first and second lubricating fluids, and the silanizing agent, the reaction with silanizing agents may be conducted prior to the introduction of the first and/or second lubricating fluid, or after both the first and second lubricating fluids are present. The use of silanizing agent to treat the polymer compositions may produce beneficial effects. Those effects can include an increased ability of the treated polymer to retain the lubricating fluids applied to it, increased oleophobicity, and increased hydrophobicity (e.g., as reflected in reduced roll off angles for water and oils).

Embodiments of the compositions described herein include systems comprising at least two parts (Part A and Part B). Part A is a silicone resin-based formulation that produces an elastomeric coating with an ability to absorb and retain lubricating fluids in the cured elastomer. Part A comprises monomers, functionalized oligomers, and/or functionalized polymers, and optionally comprises HP- or HP/OP-particles. Part A of the composition may, or may not, be provided as a curable composition, or may require an initiator or catalyst addition. Part B is a first lubricating fluid (e.g., silicone fluids such as PDMS) that is combined with Part A prior to exposing the combination of Parts A and B to conditions that will result in curing the composition. The system may further include a third component (“Part C”) comprising a second lubricating fluid (which may be the same as or different than the first lubricating fluid) to be applied as a top coat to the cured silicone. The second lubricating fluid of Part C can form, among other things, a thin layer of fluid on the fluid infused silicone composition produced by curing the mixture of Parts A and B. In one embodiment Parts A and B are mixed or “premixed” to form a Part AB composition, which as noted above may require the addition of an initiator or catalyst to become curable. The systems described herein may also contain a composition comprising HP- or HP/OP-particles (Part A′) that can be applied to the uncured Part A or Part AB composition so that the particles are localized (there are a greater number of particles) at, on, or adjacent to the surface of the article or coating, with the result that the particles are not distributed uniformly throughout the coating or article. The proportions of materials appearing in the components of Parts A and B may be taken from those ranges appearing elsewhere in the disclosed methods and Certain Embodiments set forth in this disclosure.

The article or coating resulting from the use of such compositions comprises a surface that inhibits deposition/attachment of bacteria and other organisms. As a result, biofouling and the growth of organisms (e.g., bacteria, fungus, barnacles, tubeworms and algae) can be impeded. As biofouling accumulation will not adhere well to the surface, it can be easily removed (e.g., by rinsing/spraying with water). When and where necessary or desirable the surface of articles and coatings can be refreshed by reapplication of a second lubricating fluid (Part C).

The compositions described herein may, prior to curing, be applied as coatings by spraying, brushing, rolling, curtin coating, spin coating, etc., which is to say the uncured pre-polymer compositions may be “paintable” compositions. Depending on the monomers, functionalized oligomers, and/or functionalized polymers and the amount of first silicone fluid contained in the composition it may be necessary or desirable to dilute the composition with a suitable solvent to achieve a suitable viscosity for application. In some embodiments the composition to be applied may have a viscosity from about 1-10,000 centistokes (cSt). For example, thinner compositions such as those applied by spraying may have a viscosity in a range from 1-1,500 cSt (e.g., 1 to 10, 5 to 20, 10 to 50, 20 to 100, 100 to 300, 200 to 500, 500 to 1,000 or 1,000 to 1,500 cSt) as determined by ASTM D5125-10(2014) Standard Test Method for Viscosity of Paints and Related Materials by ISO Flow Cups. Where materials are to be applied by other techniques, such as rolling, spin coating, or brushing, higher viscosities may be employed such as in the range of 1,000 to 10,000 cSt per ASTM D5125-10 (e.g., 1,000 to 1,500, 1,000 to 2,000, 2,000-5,000, 3,000 to 6,000, 5,000 to 8,000, or 7,500 to 10,000 cSt). A variety of solvents may be utilized including organic ethers, esters, ketones, and alcohols, and more volatile siloxanes. Some examples of solvents that may be employed include: methanol; ethanol; isopropanol; methylformate; ethylformate; methylacetate; ethylacetate; propyl acetate; butylacetate; n-butylacetate; sec-butylacetate; tertbutylacetate; acetone; methylethylketone; methylisobutyl ketone; diethyl ether; dimethyl ether; methyl ethyl ether; methyl butyl ether; ethyl butyl ether; tert-butyl ether; hexamethylcyclotrisiloxane (D3); octamethylcyclotetrasiloxane (D4); decamethylcyclopentasiloxane (D5); dodecamethylcyclohexasiloxane (D6); and mixtures thereof. Selection of the solvent(s) utilized needs to take into account the chemistry and compatibility of the siloxane components, the first and second lubricating fluids, and the residue of the solvent that may remain trapped in the composition which may not be compatible with the intended use of the coating. A variety of primers may be applied to substrates (surfaces) to improve the adhesion of coatings to the substrates. The selection of primers can be made based upon the specific chemistry of the silicone elastomers. For example, moisture cure compositions that react to alcohol groups may be applied over primers that provide that functionality. Heat cure silicone compositions that react to alkene (e.g., vinyl) groups utilize primer groups that introduce such functionalities to the surface. In one such embodiment, vinyl triethoxy silane is used with heat cure compositions so that the silicone elastomer formed would adhere to substrates where the ethoxy silane can react.

### 6.0 Applications

In addition to describing the preparation of compositions for forming non-stick silicone compositions, in some embodiments the articles, or portions of articles, formed from such compositions are HP or HP/OP. In some embodiments the articles prepared from materials and methods described herein are used in biomedical and non-medical devices and applications.

As the non-stick materials described herein provide resistance to fouling, including fouling by biological materials, and can be flexible, the materials are particularly suitable for use in preparing tubing and catheters used in various biomedical applications where fouling and clogging are problematic. Articles prepared from the materials described herein, particularly when they are hydrophobic or superhydrophobic, have little if any ability to induce the clotting of blood. Accordingly, articles prepared from the internally lubricated materials described herein find use in articles contacted with blood, such as items (e.g., tubing) used for transferring blood or as part of arterial/venous catheters. As hydrophobic surfaces do not tend to induce clotting when contacted with blood, the materials described herein may find use in preparing medical devices and products for carrying fluids and/or gases, such as in drains (e.g., to drain anatomical cavities), or in equipment for medical infusion or to apply suction, transfusion equipment, and ports. In some embodiments the tubing, drains, and ports may form or be part of medical devices including, but not limited to, peritoneal dialysis equipment, feeding tubes, nasogastric tubes, urostomy equipment, colostomy equipment, Foley catheters, urethral catheters, mucus traps (e.g., Luken suction traps) and associated tubing, tracheostomy tubes, endotracheal tubes, arterial and/or venous infusion sets, central lines, shunts, artificial vessels, drains, sinus drains, intraparenchymal drains, extracranial ventricular drains, spinal drains (e.g., lumbar drains) and equipment for bronchial aspiration. The tubing may also be employed in laparoscopic and/or arthroscopic procedures, such as for the delivery or removal of liquids, or as a covering on portions of equipment (e.g., where the tubing is HP or HP/OP on its exterior surface). The tubing may also be used in equipment/devices for the gathering of blood (e.g., phlebotomy) or in the processing of blood into one or more components such as serum, packed red blood cells, and/or platelets.

In one set of embodiments the articles prepared from/with materials described herein may be a catheter or other article for medical applications. Such embodiments include, but are not limited to, uretic catheters (e.g., a Foley catheter or a suprapubic catheter), intravenous catheters (e.g., peripheral venous catheter), Quinton catheters (double or triple lumen for hemodialysis), intrauterine catheters, central venous catheters, Swan-Ganz catheters, catheters for angioplasty, catheters for angiography, catheters for balloon septostomy, embryo transfer catheters, umbilical line, catheters for balloon sinuplasty, catheters for cardiac electrophysiology testing, catheters for ablation, catheters for blood pressure measurement, catheters for intracranial pressure measurement, administration of anesthetics (e.g., epidural administration, administration in the subarachnoid space, or around a major nerve bundle such as the brachial plexus), tubes and other articles for administration of oxygen, volatile anesthetic agents, and other breathing gases into the lungs using a tracheal tube, articles for subcutaneous administration of insulin or other medications, and Tuohy-Borst adapters.

In another set of embodiments, the articles prepared from/with materials described herein may be a shunt or other article for medical applications including, but not limited to, cardiac shunts, cerebral shunts, lumbar-peritoneal shunts, and peritoneovenous shunts.

In another set of embodiments the articles prepared from/with materials described herein may be a shunt or other article for medical applications including, but not limited to, expandable coronary stents, vascular stents and biliary stents, stents used to allow the flow of urine between kidney and bladder, and stents used to expand a narrowed structure such as in atherosclerosis.

In other embodiments the articles prepared from/with materials described herein may be a surgical instrument or other article for medical applications including, but not limited to, forceps, clamps, occluders, retractors, distractors, lancets, trocars, rongeurs, harmonic scalpels, scalpels, dilators, suction tips or tubes, surgical staples, irrigation and injection needles and tubes, scopes, probes (e.g., fiber optic or tactile probes), ultrasound tissue disruptors, rulers, calipers, cryotomes, and cutting guides.

In one embodiment the article prepared from/with materials described herein is selected from the group consisting of: intravenous cannula, umbilical catheters, endotracheal tubes, suction catheters, oxygen catheters, stomach tubes, feeding tubes, lavage tubes, rectal tubes, urological tubes (e.g., Foley catheters), irrigation tubes, trocar catheters, heart catheters, aneurysm shunts, articles for use in dialysis equipment (hemodialysis or peritoneal dialysis), extracorporeal circuits, and stenosis dilators.

In one embodiment the article prepared from/with materials described herein is selected from the group consisting of: arterial ports, venous ports, peritoneal ports (e.g., peritoneal dialysis port), and colostomy ports.

As the non-stick materials described herein provide resistance to fouling and can be hydrophobic or hydrophobic and oleophobic they also find use in a variety of other application including, but not limited to, pipelines, windmills (wind turbines), radiators and heat exchangers, coatings for circuit boards, self-cleaning surfaces (e.g., oven surfaces), and numerous surfaces on fresh water and marine vessels including boat hulls. Other equipment used in fresh water, brackish water, or salt water environments, including equipment that is not exposed to the high rates of flow to which boat hulls are subjected, may also be treated with the present compositions including, but not limited to, buoys, parts of floating docks, hand rails and ladders immersed in water, fish/shellfish farming equipment and devices, and the like.

Assessment of cured coatings (e.g., an internally lubricated cured coating) and articles formed from the compositions set forth herein to resist the accumulation of tightly adherent material after exposure to fresh water, brackish water, or seawater environments may be conducted by coating substantially square flat panels of substrate (about 10 cm by 10 cm) with the desired coating (e.g., an internally lubricated cured coating) and establishing the initial weight and surface area of the coated substrate panels. The coated substrate panels are suspended in fresh water, brackish water, or seawater. After a specified period of time (e.g., 100, 250, or 365 days), the substrate panels are removed from the water. Following removal from the fresh, brackish or salt water, the substrates are rinsed with a stream (jet) of fresh 22° C. water at 40 psi (at a flow rate of 15 liters per minute) directed at (e.g., perpendicular to) the surface (about 1 minute for each side) to remove loosely adherent material. The rinsed substrates are dried by blotting with absorbent paper towels until no surface water can be seen and then air dried at 22° C. overnight. After the drying process the weight of tightly adherent material is determined by weighing each panel, subtracting the initial weight of the panel, and normalizing mass of adherent material in the units of grams per 100 cm² of coated surface (100 cm² of the exposed surface of the coating).

In an embodiment the internally lubricated cured coating accumulates less than 5 or less than 10 grams of tightly adherent material per 100 cm² of coated surface (100 cm² of the exposed surface of the coating) after 100 days submerged in a fresh water, brackish water, or seawater environment at a depth of 1-2 meters.

In an embodiment the internally lubricated cured coating accumulates less than 10 or less than 20 grams of tightly adherent material per 100 cm² of coated surface (100 cm² of the exposed surface of the coating) after 250 days submerged in a fresh water, brackish water, or seawater environment at a depth of 1-2 meters.

In an embodiment the internally lubricated cured coating accumulates less than 15, less than 20 or less than 25 grams of tightly adherent material per 100 cm² of coated surface (100 cm² of the exposed surface of the coating) after 365 days submerged in a fresh water, brackish water, or seawater environment at a depth of 1-2 meters.

The hardness of a composition after curing depends upon, among other things, the amount of lubricating fluid present, the amount of crosslinking within the composition, and the type and amount of HP- or HP/OP-particles present (particularly where the particles are functionalized to crosslink the siloxane components during curing). Increasing the amount of crosslinking components that can form three, four or more bonds during curing and reducing the amounts of lubricating fluids, will both tend to increase hardness.

For articles to be formed from the compositions the desired hardness of the article will depend upon the specific application. Cured compositions of the present disclosure may have Shore A hardness over the range from about 10 to at least about 80 (e.g., about 10 to about 30, about 30 to about 60, or about 60 to about 80). For example, the compositions recited herein can have properties tailored for different catheter components. For example, typical durometers values for catheter tips can be from about 70 to 85 Shore A, balloons from about 20 to about 30 Shore A, shafts from about 60 to about 80 Shore A, and connectors from about 50 and 70 Shore A.

In a similar manner, when the compositions are applied as coatings they may have a range of hardness values that may be expressed by their film hardness using ASTM D 3363-00, which is the “Standard Test Method for Film Hardness by Pencil Test.” Coatings prepared with the methods and compositions described herein may have hardness values in the range of 6B to 6H (e.g. about 6B to about 3B, about 6B to about HB, about 3B to about B, about B to about F, about HB to about H, about F to about H, about H to about 2H, about H to about 3H, about 2H to about 3H, about 3H to about 4H, about 4H to about 5H, or about 5H to about 6H).

### 7.0 Certain Embodiments

1. A method of preventing fouling of all or part of a substrate immersed in a fresh water, brackish water, or seawater environment by forming an internally lubricated coating, the method comprising;

i) combining polymerizable monomers, functionalized oligomers, and/or functionalized polymers, which can be polymerized to prepare silicone elastomers, and HP-particles with a first lubricating fluid to form an internally lubricated pre-polymer composition and applying the composition to a substrate to form a coating of the (internally lubricated) pre-polymer composition having an exposed surface on all or part of the substrate;

ii) curing the coating of the pre-polymer composition by polymerizing the monomers, functionalized oligomers, and/or functionalized polymers to form a cured coating; and

iii) applying a second lubricating fluid to all or part of the cured coating, thereby forming an internally lubricated cured coating having an exposed surface;

wherein the first lubricating fluid comprises greater than 1.0% (e.g., greater than 10%, such as 10% to 20%, 20% to 30%, 30% to 40%, 40% to 50%, or 50% to 60%) of the total weight of the monomers, functionalized oligomers, functionalized polymers, all particles present in the pre-polymer composition, and the first lubricating fluid; and

wherein the internally lubricated cured coating
(a) accumulates less than 5, less than 10, less than 15, less than 20, or less than 25 grams of tightly adherent material per 100 cm² of the exposed surface (100 cm² of the exposed surface of the coating) after 100 days submerged in a fresh water, brackish water, or seawater environment at a depth of 1-2 meters,
(b) accumulates less than 5, less than 10, less than 15, less than 20, or less than 25 grams of tightly adherent material per 100 cm² of the exposed surface (100 cm² of the exposed surface of the coating) after 250 days submerged in a fresh water, brackish water, or seawater environment at a depth of 1-2 meters,
(c) accumulates less than 5, less than 10, less than 15, less than 20, or less than 25 grams of tightly adherent material per 100 cm² of the exposed surface (100 cm² of the exposed surface of the coating) after 365 days submerged in a fresh water, brackish water, or seawater environment at a depth of 1-2 meters,
(d) after being rinsed with a stream (jet) of fresh 22° C. water at 40 psi (at a flow rate of 15 liters per minute) directed at its surface to remove loosely adherent material, achieves an ASTM D5479-94 (Reapproved 2013) or an ASTM D3623-78a (2012) rating of greater than 85, greater than 90, greater than 95, or a rating of 100 after 100 days submerged in a fresh water, brackish water, or seawater environment at a depth of 1-2 meters,
(e) after being rinsed with a stream (jet) of fresh 22° C. water at 40 psi (at a flow rate of 15 liters per minute) directed at its surface to remove loosely adherent material, achieves an ASTM D5479-94 (Reapproved 2013) or an ASTM D3623-78a (2012) rating of greater than 75, greater than 80, or greater than 85 after 250 days submerged in a fresh water, brackish water, or seawater environment at a depth of 1-2 meters, and/or
(f) after being rinsed with a stream (jet) of fresh 22° C. water at 40 psi (at a flow rate of 15 liters per minute) directed at its surface to remove loosely adherent material, achieves an ASTM D5479-94 (Reapproved 2013) or an ASTM D3623-78a (2012) rating of greater than 60, greater than 65, greater than 70, greater than 75, greater than 80, or greater than 85 after 365 days submerged in a fresh water, brackish water, or seawater environment at a depth of 1-2 meters.
   2. The method of embodiment 1, wherein the polymerizable monomers, functionalized oligomers, and/or functionalized polymers can be cured by heating and/or exposure to water (e.g., moisture curing).
   3. The method of embodiment 1, wherein the polymerizable monomers, functionalized oligomers, and/or functionalized polymers can be cured by exposure to UV and/or visible light.
   4. The method of any of embodiments 1-3, wherein the internally lubricated pre-polymer composition comprises up to 85% by weight of HP-particles (hydrophobic, or hydrophobic and oleophobic particles) or precursors thereto (e.g., from about 0.1% to about 5%, from about 0.5% to about 10%, from about 10% to about 20%, from about 10% to about 50%, from about 20% to about 40%, from about 40% to about 60%, from about 50% to about 85%, or from about 60% to about 85% by weight), with a size from about 2 nm to about 50 microns;

wherein the HP-particles may have been treated with one or more siloxanes, one or more silizanes, and/or one or more silanizing agents to provide HP or HP/OP properties; and

wherein the weight percent of the HP-particles is based upon the weight of the particles present in the uncured composition and the polymerizable components (curable monomers, oligomers, and functionalized polymers that can be covalently linked during curing).

In such an embodiment the particles may comprise up to 45% by weight of particles that do not covalently bind to the siloxane during curing. In another such embodiment the composition comprises up to 55% of particles that do covalently attach to the siloxane during curing.
5. The method of any of embodiments 1-4, wherein, prior to curing, all or part of the exposed surface of the internally lubricated pre-polymer composition is contacted with hydrophobic, or hydrophobic and oleophobic, particles from about 2 nm to about 50 microns that have been treated with a siloxane, silizane, and/or silanizing agent. In such an embodiment the contacting of the surface (top coating) may be accomplished by using particles applied by a stream of gas, in a volatile solvent or in an independently selected first lubricating fluid.
6. The method of any of embodiments 1-5 wherein the first lubricating fluid and/or the second lubricating fluid are selected independently to have either hydrophobic or hydrophobic and oleophobic properties.
7. The method of any of embodiments 1-6 wherein the first lubricating fluid and/or the second lubricating fluid are selected independently from alkanes, fluoroalkanes, alkenes, fluoroalkenes, silicone fluids, mineral oils, plant oils, fatty esters (e.g., ethylene glycol, propylene glycol or glycerol), fatty ethers (e.g., alkyl or alkenyl ethers of ethylene glycol, propylene glycol or glycerol), phosphate esters or silicate esters or combinations thereof. In such embodiments the first lubricating fluid may be added to the pre-polymer composition such that it is present at up to 70% by weight of the total composition (e.g., 0%-5%, 5%-10%, 10%-20%, 10%-30%, 20%-40%, 20%-50%, 30%-50%, 30%-70%, 40%-70%, or 50%-70%).
8. The method of any of embodiments 1-7, wherein the first lubricating fluid and/or the second lubricating fluid are silicone fluids selected independently from alkyl or fluoroalkyl silicone fluids comprising 2, 3, 4, 5, 10, 15, 20, 25, 30, 40, 50, 100 or more groups of the form:

(—O—Si(G1)(G2)-)

where each G1 and G2 are selected independently from methyl, ethyl, propyl, isopropyl, n-butyl, isobutyl, and sec-butyl, any or all of which may be fluorinated. In such embodiments, the first and/or second lubricating fluids may not include more than 1% (or alternatively 2%, 3%, 4% or 5%) by weight (of the lubricating fluid) of one or more siloxanes that have a molecular weight less than 250, 300, 350, 400, or 450 grams/mole. In one such embodiment, the first and/or second lubricating fluids may not include more than 1% by weight of the lubricating fluid of a siloxane that has a molecular weight less than 450 grams/mole. In other such embodiments, the first and/or second lubricating fluids comprise less than 1% (or alternatively 2%, 3%, 4% or 5%) by weight of a PDMS fluid that in its pure state would have a viscosity less than 1 cSt, 2 cSt, 3 cSt, or 4 cSt at 20° C. under ASTM D445-15a. In one such embodiment, the first and/or second lubricating fluids may not include more than 1% by weight of a PDMS fluid that in its pure state would have a viscosity less than 3 cSt, or 4 cSt at 20° C. under ASTM D445-15a.
9. The method of any of embodiments 1-8, wherein the first lubricating fluid and/or the second lubricating fluid comprise one or more, two or more, or three or more independently selected silicone fluids.
10. The method of any of embodiments 1-9, wherein the first lubricating fluid and/or the second lubricating fluid comprise independently selected linear or branched silicone fluids.
11. The method of embodiment 10, wherein the first lubricating fluid and/or the second lubricating fluid comprise independently selected polydimethylsiloxanes (PDMS) or polydiethylsiloxanes (PDES).
12. The method of any of embodiments 1-11, wherein the first lubricating fluid has a kinematic viscosity at a range selected from about 2 cSt (centiStokes) to 100 cSt (e.g., 2-5, 3-7, 2-10, 4-20, 4-25, 4-50, 7-15, 7-20, 10-30, 10-50, 10-100, 20-40, 20-50, 20-70, 20-100, 30-50, 30-70, 30-100, 40-80, 40-100, 50-75, 50-100, or 80-100 cSt) at 20 degrees Centigrade.
13. The method of any of embodiments 1-12, wherein the second lubricating fluid has a kinematic viscosity at a range selected from about 2 cSt (centiStokes) to 1,000 cSt (e.g., 2-5, 3-7, 2-10, 4-20, 4-25, 4-50, 7-15, 7-20, 10-30, 10-50, 10-100, 20-40, 20-50, 20-70, 20-100, 30-50, 30-70, 30-100, 40-80, 40-100, 50-75, 50-100, 100-250, 250-500, 500-800, or 800-1,000 cSt) at 20 degrees Centigrade.
14. The method of any of embodiments 1-13, wherein the first and second lubricating fluids have a difference in kinematic viscosity greater than 1, 2, 5, 7, 10, 20, 30, 40, 50, 60, 70, 80, 90, 98, 100, 200, 300, 500, 750, 800 or 900 cSt, where the kinematic viscosity is determined at 20 degrees Centigrade.
15. The method of any of embodiments 1-14, wherein the first and second lubricating fluids have a difference in kinematic viscosity in a range selected from about 2 to about 7, about 2 to about 10, about 3 to about 15, about 4 to about 10, about 5 to about 25, about 10 to about 25, about 15 to about 30, about 15 to about 50, about 25 to about 50, about 25 to about 75, about 30 to about 60, about 30 to about 90, about 40 to about 80, or about 50 to about 100 (e.g., 98) cSt, where the kinematic viscosity is determined at 20 degrees Centigrade.
16. The method of any of embodiments 4-15, wherein the HP-particles comprise a metal oxide or metalloid oxide.
17. The method of any of embodiments 4-16, wherein the HP-particles comprise silica (e.g., SiO₂), alumina (e.g., Al₂O₃), or an oxide of titanium (e.g., TiO₂) or an oxide of zinc.
18. The method of any of embodiments 4-17, wherein the HP-particles comprise a fumed silica or fumed alumina.
19. The method of any of embodiments 4-18, wherein the HP-particles have a Brunauer, Emmett, and Teller (BET) surface area greater than 90, 100, 125, 150, 175, 200, 225, 250, 275 or 300 m²/g or in a range from about 90 to about 350 m²/g (e.g., about 90 to about 150, about 90 to about 300, about 100 to about 150, about 100 to about 200, about 100 to about 250, about 100 to about 350, about 150 to about 250, about 150 to about 300, about 150 to about 350, about 200 to about 250, about 200 to about 300, about 200 to about 350, about 250 to about 300, about 250 to about 350, or about 300 to about 350 m²/g).
20. The method of any of embodiments 4-19, wherein the particles are treated with a siloxane and have siloxane covalently bound to the particles.
21. The method of embodiment 20, wherein the siloxane covalently bound to the particle is PDMS and/or PDES.
22. The method of any of embodiments 4-19, wherein the one or more silanizing agents are compounds of formula (I)

R₄₋ₙSi—Xₙ (I)

where

n is an integer selected from 1, 2, or 3;

each R is independently selected from
(i) alkyl or cycloalkyl group optionally substituted with one or more fluorine atoms,
(ii) C_{1 to 20} alkyl optionally substituted with one or more substituents independently selected from the group consisting of fluorine atoms and C_{6 to 14} aryl groups, which aryl groups are optionally substituted with one or more independently selected halo, C_{1 to 10} alkyl, C_{1 to 10} haloalkyl, C_{1 to 10} alkoxy, and/or C_{1 to 10} haloalkoxy substituents,
   (iii) C_{2 to 8} or C_{6 to 20} alkyl ether optionally substituted with one or more substituents independently selected from fluorine and C_{6 to 14} aryl groups, which aryl groups are optionally substituted with one or more independently selected halo, C_{1 to 10} alkyl, C_{1 to 10} haloalkyl, C_{1 to 10} alkoxy, and/or C_{1 to 10} haloalkoxy substituents,
   (iv) C_{6 to 14} aryl, optionally substituted with one or more substituents independently selected from halo, alkoxy, and/or haloalkoxy substituents,
   (v) C_{2 to 20} alkenyl or C_{2 to 20} alkynyl, optionally substituted with one or more substituents independently selected from halo, alkoxy, and/or haloalkoxy, and
   (vi) —Z—((CF₂)_{q}(CF₃))ᵣ, wherein Z is a C_{1 to 12} and/or a C_{2 to 8} divalent alkane radical or a C_{2 to 12} divalent alkene or alkyne radical, q is an integer from 1 to 12, and r is an integer from 1 to 4;
each X is independently selected from the group consisting of —H, —Cl, —I, —Br, —OH, —OR², —NHR³, and —N(R³)₂;
each R² is an independently selected C_{1 to 4} alkyl or C_{1 to 4} haloalkyl group; and
each R³ is an independently selected H, C_{1 to 4} alkyl, or C_{1 to 4} haloalkyl group; and wherein
each C_{1 to 4} alkyl or haloalkyl group is independently selected to comprise 1, 2, 3, or 4 carbon atoms and may be linear or branched,
each C_{2 to 8} alkyl group is independently selected to comprise 2, 3, 4, 5, 6, 7, or 8 carbon atoms and may be linear or branched,
each C_{6 to 20} alkyl group is independently selected to comprise 6, 7, 8, 9, 10, 11, 12, 13, 14, 15, 16, 17, 18, 19, or 20 carbon atoms and may be linear or branched,
each C_{1 to 10} alkyl, alkoxy, haloalkoxy, or haloalkyl group is independently selected to comprise 1, 2, 3, 4, 5, 6, 7, 8, 9, or 10 carbon atoms and may be linear or branched, and
each C_{1 to 20} alkyl or cycloalkyl group is independently selected to comprise 1, 2, 3, 4, 5, 6, 7, 8, 9, 10, 11, 12, 13, 14, 15, 16, 17, 18, 19, or 20 carbon atoms and may be linear or branched.
   23. The method of embodiment 22, wherein the particles are treated with a silanizing agent that comprises a vinyl group.
   24. The method of any of embodiments 1-23, wherein the first silicone fluid comprises up to 50% by weight of the pre-polymer composition (e.g., from 1%-10%, 1%-20%, 1%-30%, 1%-40%, 5%-10%, 5%-20%, 5%-30%, 5%-40%, 5%-50%, 7.5%-15%, 7.5%-20%, 7.5%-30%, 7.5%-40%, 7.5%-50%, 10%-20%, 10%-30%, 10%-40%, 10%-50%, 15%-20%, 15%-30%, 15%-40%, 15%-50%, 20%-30%, 20%-40%, 20%-50%, 30%-40%, 30%-50%, or 40%-50% by weight).
   25. The method of any preceding embodiment, wherein the internally lubricated cured coating has a water slide angle less than about 5° (e.g., about 5° to about 1°, about 5° to about 3°, or about 3° to about 1°).
   26. The method of any preceding embodiment, wherein the internally lubricated cured coating has a greater amount (per cubic volume) of the second lubricating fluid at or on a portion of the exposed surface of the cured coating than the amount of second lubricating fluid within said portion of the internally lubricated cured coating (e.g., there is more second lubricating fluid on the exposed surface of a section of the cured coating than within that section of coating).
   27. The method of any preceding embodiment, wherein at least one portion of the cured coating has a gradient of the second lubricating fluid with the greatest amount of second lubricating fluid at or on a region on the exposed surface of the cured coating and an amount of second lubricating fluid that decreases within the cured coating along a line perpendicular to said region on the exposed surface.
   28. The method of any preceding embodiment, wherein less than 5%, 4%, 3%, 2%, 1%, 0.5%, or 0.1% of the first and/or second lubricating fluids becomes covalently bound to the coating (e.g., after curing).
   29. The method of any preceding embodiment, wherein the internally lubricated cured coating formed from said polymerizable monomers, functionalized oligomers, and/or functionalized polymers is non-porous.
   30. The method of any preceding embodiment, wherein the internally lubricated cured coating has a surface arithmetical mean roughness less than about 15, 10, 5, 4, 3, 2, 1, 0.5, 0.25, 0.2, or 0.1 microns, or an arithmetical mean roughness in a range selected from about 15 microns to about 500 microns, about 0.05 microns to about 0.2 microns, about 0.1 microns to about 2.5 microns, about 0.1 microns to about 25 microns, about 2.5 microns to about 10 microns, about 10 microns to about 25 microns, about 15 microns to about 35 microns, about 25 microns to about 75 microns, about 50 microns to about 100 microns, about 75 microns to about 100 microns, about 75 microns to about 150 microns, about 100 microns to about 150 microns, about 100 microns to about 200 microns, about 125 microns to about 175 microns, about 150 microns to about 200 microns, about 175 microns to about 250 microns, about 200 microns to about 250 microns, about 200 microns to about 300 microns, about 225 microns to about 300 microns, about 250 microns to about 350 microns, about 300 microns to about 400 microns, about 350 microns to about 450 microns, and about 400 microns to about 500 microns.
   31. The method of any preceding embodiment, wherein the HP-particles are not covalently bound to the internally lubricated cured coating.
   32. The method of any of embodiments 1-30, wherein some or substantially all of the HP-particles are covalently bound to the internally lubricated cured coating.
   33. The method of any preceding embodiment, wherein the internally lubricated cured coating displays hydrophobic or hydrophobic and oleophobic properties.
   34. The method of any preceding embodiment, wherein the internally lubricated cured coating has a water roll off angle (water slide angle) that is less than 16, 14, 12, 10, 9, 8, 7, 6, 5, 4, 3, 2, or 1 degrees.
   35. The method of any preceding embodiment, wherein the internally lubricated cured coating has a water roll off angle (water slide angle) less than about 5 degrees prior to Taber abrasion. In such an embodiment, the article may have a water slide angle increase by less than 12 degrees when the article is subject to 100 cycles (revolutions) of Taber abrasion using a CS-0 wheel using a 250 gram load at 72 RPM at 22° C. In another such embodiment, the article may have a water slide angle increase by less than 10 degrees when the article is subject to 100 cycles (revolutions) of Taber abrasion using a CS-0 wheel using a 250 gram load at 72 RPM. In another such embodiment, the article may have a water slide angle increase by less than 8 degrees when the article is subject to 100 cycles (revolutions) of Taber abrasion using a CS-0 wheel using a 250 gram load at 72 RPM.
   36. The method of any preceding embodiment, wherein the internally lubricated cured coating has a Shore A hardness in the range from about 10 to about 80. In such an embodiment the Shore A hardness may be in a range selected from about 10 to about 30, from about 30 to about 60, or from about 60 to about 80.
   37. The method of any preceding embodiment, wherein the internally lubricated cured coating has an ASTM D 3363-00 hardness from about 6B to about 6H. In such an embodiment the hardness may be in a range from about 6B to about 3B, from about 6B to about HB, from about 3B to about B, from about B to about F, from about HB to about H, from about F to about H, from about H to about 2H, from about H to about 3H, from about 2H to about 3H, from about 3H to about 4H, from about 4H to about 5H, or from about 5H to about 6H.
   38. The method of any preceding embodiment, wherein the coating of the pre-polymer composition is applied to all or part of the substrate as a layer from about 20 microns to about 750 microns (e.g., 20-100, 100-250, 250-500, or 500-750 microns).
   39. The method of any preceding embodiment, wherein the pre-polymer composition optionally comprises one or more solvents and has a viscosity less than 10,000 cSt as determined by ASTM D5125-10. In such an embodiment, the viscosity may be less than 5,000 cSt as determined by ASTM D5125-10. In another embodiment, the viscosity may be less than 1,000 cSt as determined by ASTM D5125-10. In another such embodiment, the viscosity may be less than 500 cSt as determined by ASTM D5125-10. In such an embodiment, the viscosity may be less than 200 cSt as determined by ASTM D5125-10.
   40. The method of any preceding embodiment, wherein greater than 85%, 90%, 95%, 96%, 97%, 98% or 99% of the cured coating's exposed surface is prevented from fouling by tightly adherent material for up to 100 days of submersion in fresh water, brackish water, or seawater environment at a depth of 1-2 meters.
   41. A method of preventing fouling of all or part of a substrate immersed in a fresh water, brackish water, or seawater environment by forming an internally lubricated coating on the substrate, the method comprising;

i) combining polymerizable monomers, functionalized oligomers, and/or functionalized polymers, which can be polymerized to prepare silicone elastomers, and HP-particles with a first lubricating fluid to form an internally lubricated pre-polymer composition and applying the composition to a substrate to form a coating of the pre-polymer composition on all or part of the substrate;

ii) curing the coating of the internally lubricated pre-polymer composition by polymerizing the monomers, functionalized oligomers, and/or functionalized polymers to form a cured coating having a surface; and

iii) applying a second lubricating fluid to all or part of the surface of the cured coating, thereby forming an internally lubricated cured coating having an exposed surface;

wherein the first lubricating fluid comprises greater than 10% of the total weight of the monomers, functionalized oligomers, functionalized polymers, all particles present in the pre-polymer composition, and the first lubricating fluid; and

wherein greater than 70%, 75%, 80%, 85%, 90%, 95%, 96%, 97%, 98% or 99% of the cured coating's exposed surface is prevented from fouling by tightly adherent material for up to 100 days of submersion in fresh water, brackish water, or seawater environment at a depth of 1-2 meters.

### 8.0 Examples

### Example 1

A two-part, liquid silicone-based polymer system (Dow Corning®, Sylgard® 184) was prepared as recommended by the manufacturer by mixing 90 parts by weight of the elastomer (base) with 10 parts by weight of the curing agent including catalyst (e.g., platinum catalyst) to form the elastomer curing agent mixture. As the elastomer already contains a resin accelerator, no additional accelerator was added. To 60 parts by weight of the Sylgard® elastomer curing agent mixture was added 40 parts by weight of a first lubricating fluid consisting of polydimethylsiloxane (“PDMS”) having a viscosity of 5 cSt at 25° C. (Clearco Products Co. Inc., Bensalem, Pa.).

The combined Sylgard® and PDMS mixture was placed in a circular mold and allowed to cure at 93° C. overnight. The cured samples of material were substantially the same dimensions as the uncured material.

Following curing, the surfaces of the articles formed from the cured material were treated with a second silicone lubricating fluid that was applied along with a volatile carrier, octamethylcyclotetrasiloxane (D4). For this example the second lubricating fluid, which was the same as the first lubricating fluid (5 cSt PDMS) was combined with D4 to form a mixture of 30% PDMS and 70% D4 by weight. The second lubricating fluid/D4 mixture was applied to the surface of the article by immersing the article in the fluid for approximately one minute and removing the excess fluid by wiping the article.

Roll off angle testing with water at 22° C., indicated that greater than half of the droplets applied to the surface slid off or to the edge of the sample at an angle of 5° or less and, for some samples, at angles as low as 2°.

### Example 2

A sample of the liquid silicone-based polymer system was prepared as in Example 1. Aliquots of 1.1 g of the composition were mixed with 0.7 g of PDMS fluid (Clearco Products Co. Inc., Bensalem, Pa.) as a first lubricating fluid. The first lubricating fluid had the indicated viscosity (5, 20, or 50 cSt) listed in Table 4. A 1.1 g control sample (without added PDMS fluid) was also prepared. The samples were cast onto aluminum plates primed with vinyl triethoxy silane so that the silicone elastomer formed would adhere to the plates during curing. After curing at 93° C. overnight, each plate was sprayed with a top coat (second lubricating fluid) of the same PDMS fluid which had been used to prepare the coating without a carrier. After thirty minutes the excess PDMS was removed by wiping the surface.

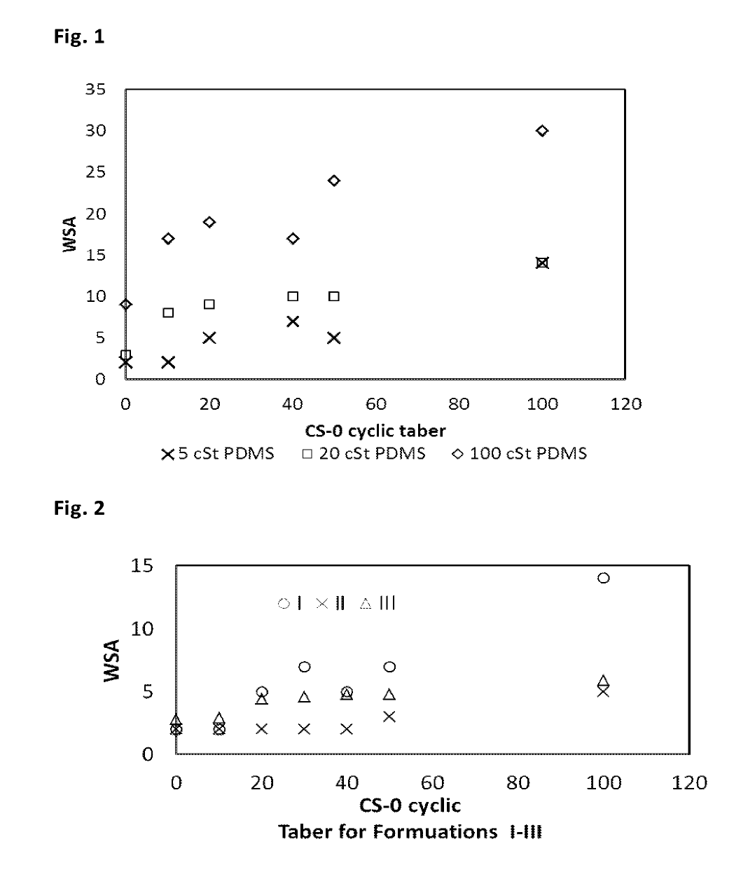

After measuring the initial water contact angle (WCA) and water slide angle (WSA), the sample was subject to abrasion using a Taber Abraser Model 503 equipped with CS-0 wheels using a 250 gram load. The WSA was measured after 10, 20, 40, 50 and 100 cycles (revolutions) of the plate at 72 RPM (See FIG. 1). The WCA was again determined after 100 cycles. The data are provided in the Table 4, below.

TABLE 4

| | PDMS | | | WCA at | | | | | | |
|---|---|---|---|---|---|---|---|---|---|---|
| SYLGARD | Fluid | PDMS Top | | 100 Taber | Initial | WSA | WSA | WSA | WSA | WSA |
| Mix | (0.7 g) | coat | Initial WCA | cycles | WSA | 10 cycles | 20 cycles | 40 cycles | 50 cycles | 100 cycles |
| 1.1 g | 5 cSt | 5 cSt (100%) | 115.5 | 116.4 | <1° | 2-7° | 5° | 7° | 5-20° | 14-29° |
| 1.1 g | 20 cSt | 20 cSt (100%) | 112.9 | 107.2 | 2.9-7.5° | 8-15° | 9-13° | 10-17° | 10-19° | 14-25° |
| 1.1 g | 50 cSt | 50 cSt (100%) | 114.4 | 101.9 | 9-16° | 17-20° | 19-25° | 17-27° | 24-35° | 30-42° |
| 1.1 g | None | 5 cSt (100%) | | | 3-6° | 3-8° | 5-14° | 8-17° | 10-19.5° | 10-28.9° |

### Example 3

Four different test samples of thermally curable PDMS compositions (SYLGARD® 184) were prepared on aluminum test plates along with a control plate utilizing unmodified SYLGARD® 184 (Formulation “0”). SYLGARD® samples were prepared by mixing 90 parts by weight of the elastomer (base) with 10 parts by weight of the curing agent including catalyst (e.g., platinum catalyst), without additional accelerator. In the first three test samples (Formulations I-III) additional siloxane components were added to the SYLGARD® prior to curing. The additional siloxanc components were added as PDMS fluid (Formulation I), PDMS bound to silica (Formulation II), or as three-dimensional crosslinked silicone particles (Formulation III). Following thermal curing, PDMS was applied to the cured coatings of Formulations I-III. In the fourth sample (Formulation IV), SYLGARDO 184 was applied to an aluminum test plate and cured, after which the cured coating received an application of PDMS fluid.
Formulation I: A total of 0.7 g of 5 cSt PDMS fluid was incorporated into 1.0 g of pre-cured SYLGARD® 184 resin (prepared per the manufacturer's instructions, see Example 2), followed by a top coat with 5 cSt PDMS fluid, which was applied after the SYLGARD® film was completely cured at 93° C. for 2 hours.
Formulation II: A total of 3.79 g of 5 cSt PDMS fluid containing 0.444 g of PDMS treated silica (AEROSIL® R202) was incorporated into 2.0 g of a pre-cured SYLGARD® 184 mixture. Following curing at 93° C. for 2 hour, the sample was top coated with 5 cSt PDMS fluid.
Formulation III: A total of 3.79 g of 5 cSt PDMS fluid containing 0.444 g crosslinked silicone particles (ShinEtsu product X-52-1621, Shin-Etsu Chemical Co., Ltd., Zhejiang Sheng, China) was incorporated into 2.0 g of a pre-cured SYLGARD® 184 mixture. Following curing at 93° C. for 2 hour, the sample was top coated with 5 cSt PDMS fluid.
Formulation IV: SYLGARD® 184 (1.0 g) was coated on aluminum plate and cured at 93° C. for 2 hour. Following curing, the coating was top coated with 0.1 ml of n-octyltrimethoxy silane in 2 mL D5 as a carrier. The top coat was allowed to dry before applying a second topcoat of 5 cSt PDMS.

For all plates receiving a top coat of PDMS the excess was wiped off before testing. The water slide angle (WSA) was determined by placing 10 drops of water on the surface of the coated plates which were placed on a level surface and slowly increasing the angle until one-half of the drops on the surface slid off or to the edge of the plate. The WSA was recorded for each coating before and after the 5 cSt PDMS fluid top coat was applied. The results obtained are shown in Table 5. The samples were also subject to abrasion using a Taber Abraser equipped with CS-0 wheels using a 250 gram load. The WSA was measured after 10, 20, 40, 50 and 100 cycles (revolutions) of the plate at 72 RPM (See FIG. 1). The Taber Abraser data are shown in FIG. 2.

TABLE 5

| | | PDMS | | | | |
|---|---|---|---|---|---|---|
| | | incorporated | | | WSA before | WSA after |
| | SYLGARD ® | in SYLGARD ® | | Surface | top coat with | top coat |
| Formula | 184 content | 184 | Curing | application | 5 cSt | with 5 cSt |
| 0 | 100% by weight^{α} | — | 93° C. for 2 | | >35° | |
| | | | hours | | | |
| I | 59% by weight^{α} | 41% by weight^{α} | 93° C. for 2 | 5 cSt PDMS | 14-16° | 14-16° |
| | | | hours | | | |
| II | 32% by weight^{α} | 60.7% by weight^{α} | 93° C. for 2 | 5 cSt PDMS | 11° | 11° |
| | | | hours | | | |
| III | 32% by weight^{α} | 60.7% by weight^{α} | 93° C. for 2 | 5 cSt PDMS | 3° | 3° |
| | | | hours | | | |

^{α}percentage by weight of the uncured composition

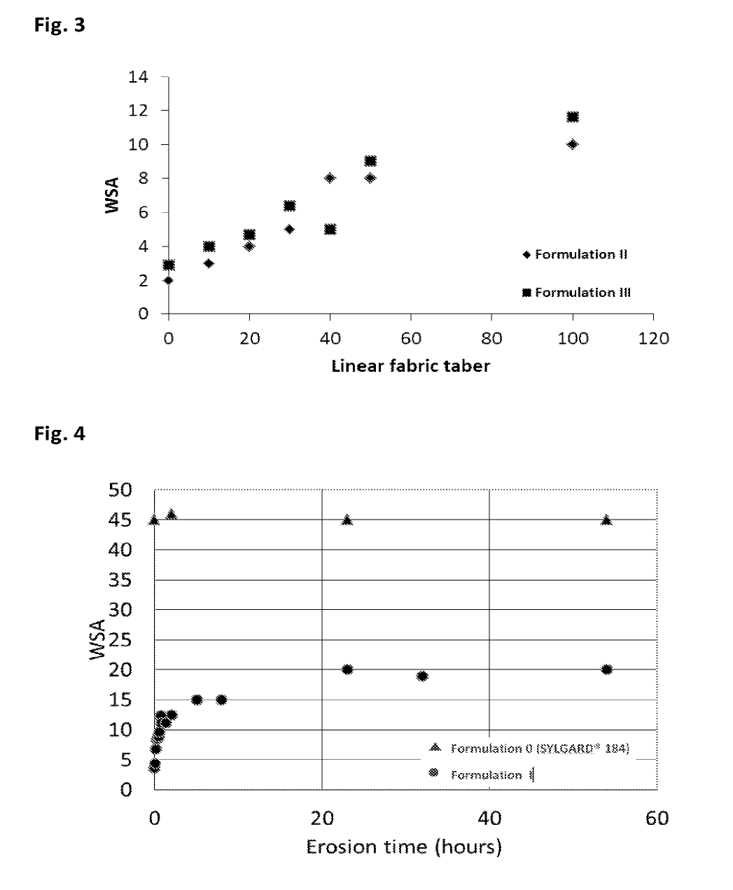

The effect on WSA of linear Taber Abraser testing using aluminum plates coated with Formulations II and III using a Taber Reciprocating Abraser (Model 5900) with the probe fitted with AATCC crockmeter fabric (AATCC Standard Crockmeter White Cloth, Item No. 0101001, Testfabrics, Inc., West Pittston, Pa.) applying a 1N force at 72 strokes per minute at 22° C. are shown in FIG. 3.

Durability in terms of resistance to loss of slide angle to flowing water (water erosion) was tested using aluminum plates coated with SYLGARD® 184 (Formulation 0) and Formulation I. The tests were conducted by placing the coated plates horizontally and allowing a stream of potable tap water at 10 psi to flow onto the coated plates. The plates were analyzed periodically over 60 hours for their WSA. Results are shown in FIG. 4.

After physical abrasion (Taber Abrader) or hours of water erosion the WSA generally increases into the 15° to 20° range. The surface can be refreshed by applying PDMS fluid top coat (spray gun or brush application). After at least 1 hour the excess topcoat can be removed by wiping with a paper towel; alternatively, excess top coat can be removed by rinsing with flowing water for 5 seconds. The refreshed surface displays a WSA approaching that of the initially applied composition.

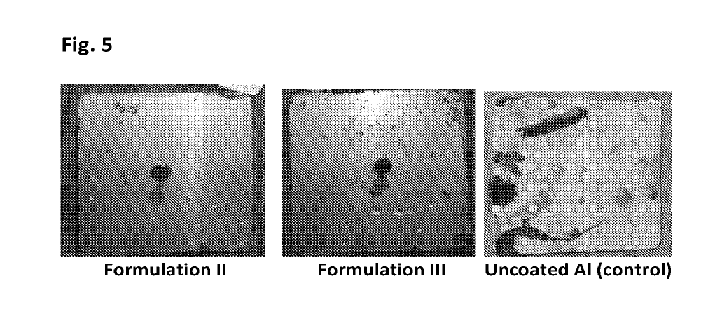

The ability of Formulations II and III to prevent fouling of aluminum plates in a marine environment was tested along with uncoated aluminum control plates. The test and control plates were placed under 5 feet (about 1.5 meters) of ocean water for 67 days in Ocean City, Md. After removing from the water, loose mud was observed on each sample. A light rinse with water removed mud from the Formulation II and III coated samples. Images of the exposed aluminum plates are shown in FIG. 5.

### Example 4

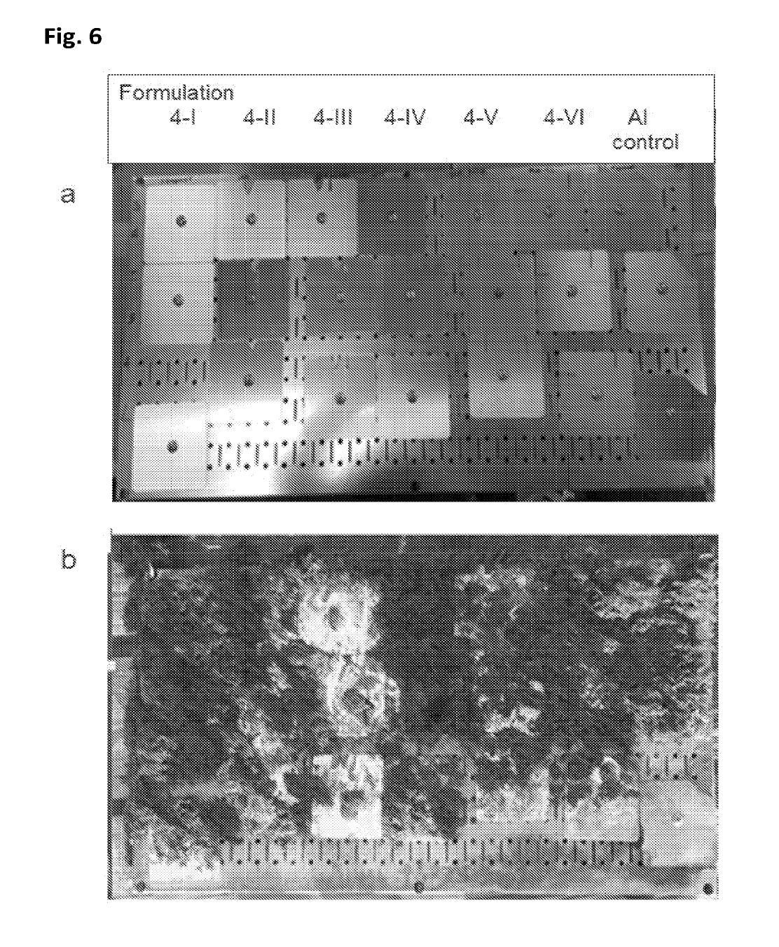

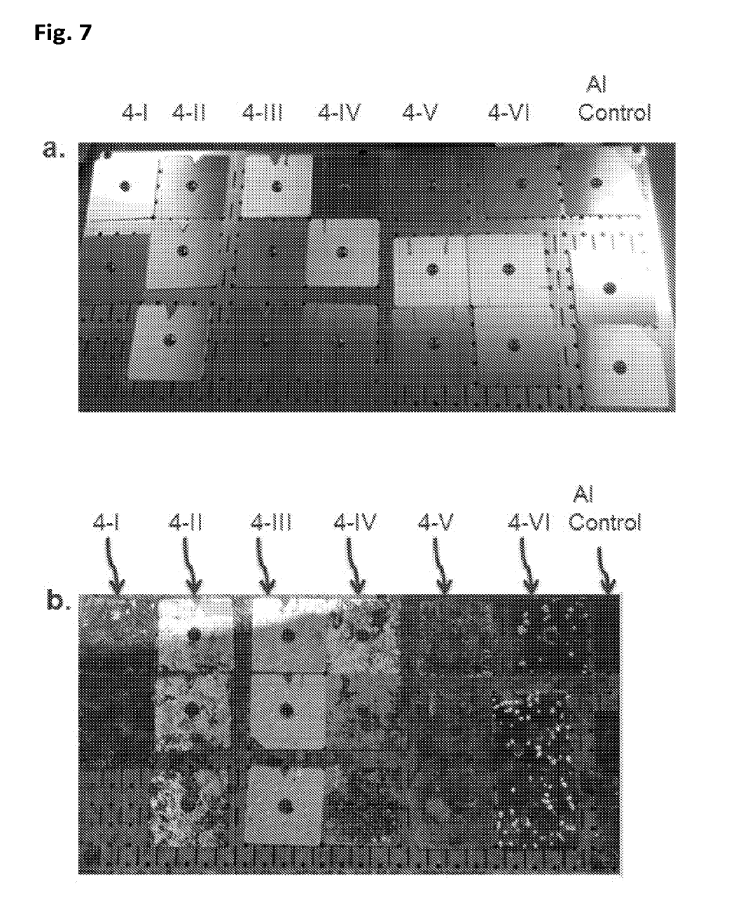

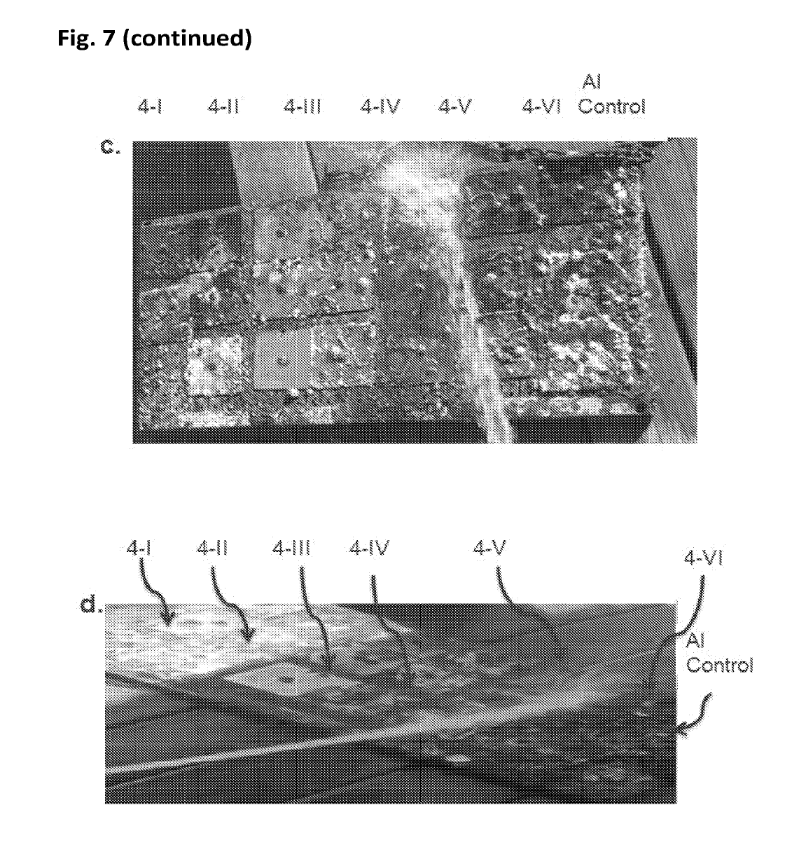

Four different test samples of PDMS compositions were prepared on aluminum test plates along with two proprietary control composition and untreated aluminum control plates as shown in FIGS. 6 and 7.
Formulation 4-I: (1^{st} column from the left) Proprietary control composition. Test for water slide angle showed the initial WSA was 20-30°.
Formulation 4-II: (2^{nd} Column from the left) 10 g SYLGARD 184 Part A was mixed with 1 g SYLGARD 184 Part B. Resulting mixture was diluted with 10 g tert-butyl acetate and sprayed on aluminum panel. Coating was cured at 93° C. for 2 hours. Cured film was not top coated with PDMS fluid. Test for water slide angle showed the initial WSA was 20-30°.
Formulation 4-III: (3^{rd} column from the left) 8 g SYLGARD 184 Part A was mixed with 0.8 g SYLGARD 184 Part B. Resulting mixture was further blended with 16.9 g PDMS fluid (5 cSt) containing 1.8 g PDMS treated fumed silica (AEROSIL® R202). The final mixture was diluted with 10 g tert butyl acetate before spraying on aluminum panels. The coating was cured at 93° C. for 2 hours. The cured film was top coated with 5 cSt PDMS fluid. Test for water slide angle showed the initial WSA was less than 3°.
Formulation 4-IV: (4^{th} column from the left) 10 g Dow Corning 1-2620 RTV silicone was diluted with 10 g tert butyl acetate and sprayed on aluminum panel. Resulting coating was cured overnight at room temperature. Test for water slide angle showed the initial WSA was 20-30°.
Formulation 4-V: (5^{th} Column from the left) 6 g Dow Corning 1-2620 RTV silicone was blended with 5.43 g PDMS fluid (5 cSt) containing 0.57 g PDMS treated fumed silica (AEROSIL® R202). Resulting mixture was diluted with 6 g tert butyl acetate before spraying on aluminum panels. Coating was cured at room temperature overnight and cured film was top coated with 5 cSt PDMS fluid. Test for water slide angle showed the initial WSA was less than 3°.
Formulation 4-VI: (6^{th} Column from the left) Second proprietary control composition. The 7^{th} column from the left contains untreated control aluminum plates.

Two sets of aluminum plates coated with formulations 4-I to 4-VI as described above and control aluminum plates (three plates for each formulation and control) were attached to a backing plate arranged in seven columns to form a test array. The test arrays were suspended submersed in two different marine environments to assess their ability to prevent fouling.

Testing in the first environment was conducted off the coast of Ocean City, Md., with the plates submersed at a depth of approximately 5 feet (about 1.5 meters) for 110 days. Results from the testing are shown in FIG. 6. Panel (a) of that figure shows the array prior to submersion. Panel (b) shows the results after submersion for 110 days without rinsing.

Testing in the second environment was conducted off the coast of Galveston, Tex., with the plates submersed at a depth of approximately 5 feet (about 1.5 meters). Results from the testing are shown in FIG. 7. Panel (a) of that figure shows the array prior to submersion. Panel (b) shows the plates after 107 days of submersion, panel (c) shows the plates after 250 days of submersion, and panel (d) shows the plates after 383 days of submersion. The photos taken in panels (b) (c) and (d) were taken after a brief rinse (about one minute) with a fresh water stream from a source providing the water at about 40 psi (about 276 kilopascals). Images of the aluminum plates tested at Ocean City, Md., are shown in FIG. 6, and those tested at Galveston, Tex., in FIG. 7.

1. A method of preventing fouling of all or part of a substrate immersed in a fresh water, brackish water, or seawater environment by forming an internally lubricated coating, the method comprising;
i) combining polymerizable monomers, functionalized oligomers, and/or functionalized polymers, which can be polymerized to prepare silicone elastomers, and HP-particles with a first lubricating fluid to form an internally lubricated pre-polymer composition and applying the composition to a substrate to form a coating of the pre-polymer composition having an exposed surface on all or part of the substrate;
ii) curing the coating of the internally lubricated pre-polymer composition by polymerizing the monomers, functionalized oligomers, and/or functionalized polymers to form a cured coating; and
iii) applying a second lubricating fluid to all or part of the cured coating, thereby forming an internally lubricated cured coating having an exposed surface;
wherein the first lubricating fluid comprises greater than 10% of the total weight of the monomers, functionalized oligomers, functionalized polymers, all particles present in the pre-polymer composition, and the first lubricating fluid; and
wherein the internally lubricated cured coating
(a) accumulates less than 5, or less than 10, grams of tightly adherent material per 100 cm² of the exposed surface after 100 days submerged in a fresh water, brackish water, or seawater environment at a depth of 1-2 meters,
(b) accumulates less than 10 or less than 20 grams of tightly adherent material per 100 cm² of the exposed surface after 250 days submerged in a fresh water, brackish water, or seawater environment at a depth of 1-2 meters, and/or
(c) accumulates less than 15, less than 20 or less than 25 grams of tightly adherent material per 100 cm² of the exposed surface after 365 days submerged in a fresh water, brackish water, or seawater environment at a depth of 1-2 meters.

2. The method of claim 1, wherein the polymerizable monomers, functionalized oligomers, and/or functionalized polymers can be cured by heating and/or exposure to water.

3. The method of claim 1, wherein the internally lubricated pre-polymer composition comprises up to 85% by weight of HP-particles (hydrophobic, or hydrophobic and oleophobic particles) or precursors thereto, with a size from about 2 nm to about 50 microns;
wherein the HP-particles have been treated with one or more siloxanes, one or more silizanes, and/or one or more silanizing agents to provide HP or HP/OP properties; and
wherein the weight percent of the HP-particles is based upon the weight of the particles present in the uncured composition and the polymerizable monomers, functionalized oligomers, and functionalized polymers that can be covalently linked during curing.

4. The method of claim 1, wherein, prior to curing, all or part of the exposed surface of the internally lubricated pre-polymer composition is contacted with hydrophobic, or hydrophobic and oleophobic, particles from about 2 nm to about 50 microns that have been treated with a siloxane, silizane, and/or silanizing agent.

5. The method of claim 1, wherein the first lubricating fluid and/or the second lubricating fluid are selected independently to have either hydrophobic or hydrophobic and oleophobic properties.

6. The method of claim 1, wherein the first and second lubricating fluids have a difference in kinematic viscosity greater than 1, 2, 5, 7, 10, 20, 30, 40, 50, 60, 70, 80, 90, 98, 100, 200, 300, 500, 750, 800 or 900 cSt, where the kinematic viscosity is determined at 20 degrees Centigrade.

7. The method of claim 6, wherein the first and second lubricating fluids have a difference in kinematic viscosity in a range selected from about 2 to about 100 cSt, where the kinematic viscosity is determined at 20 degrees Centigrade.

8. The method of claim 3, wherein the HP-particles comprise a metal oxide or metalloid oxide.

9. The method of claim 8, wherein the HP-particles comprise a fumed silica or fumed alumina having a Brunauer, Emmett, and Teller (BET) surface area greater than 90 m²/g or in a range from about 90 to about 350 m²/g.

10. The method of claim 3, wherein the one or more silanizing agents are compounds of formula (I)
R₄₋ₙSi—Xₙ (I)
where
n is an integer selected from 1, 2, or 3;
each R is independently selected from
(i) alkyl or cycloalkyl group optionally substituted with one or more fluorine atoms,
(ii) C_{1 to 20} alkyl optionally substituted with one or more substituents independently selected from fluorine atoms and C_{6 to 14} aryl groups, which aryl groups are optionally substituted with one or more independently selected halo, C_{1 to 10} alkyl, C_{1 to 10} haloalkyl, C_{1 to 10} alkoxy, or C_{1 to 10} haloalkoxy substituents,
(iii) C_{2 to 8} or C_{6 to 20} alkyl ether optionally substituted with one or more substituents independently selected from fluorine and C_{6 to 14} aryl groups, which aryl groups are optionally substituted with one or more independently selected halo, C_{1 to 10} alkyl, C_{1 to 10} haloalkyl, C_{1 to 10} alkoxy, or C_{1 to 10} haloalkoxy substituents,
(iv) C_{6 to 14} aryl, optionally substituted with one or more substituents independently selected from halo, alkoxy, or haloalkoxy substituents,
(v) C_{2 to 20} alkenyl or C_{2 to 20} alkynyl, optionally substituted with one or more substituents independently selected from halo, alkoxy, or haloalkoxy, and
(vi) —Z—((CF₂)_{q}(CF₃))ᵣ, wherein Z is a C_{1 to 12} or a C_{2 to 8} divalent alkane radical or a C_{2 to 12} divalent alkene or alkyne radical, q is an integer from 1 to 12, and r is an integer from 1 to 4;
each X is independently selected from —H, —Cl, —I, —Br, —OH, —OR², —NHR³, or —N(R³)₂;
each R² is an independently selected C_{1 to 4} alkyl or C_{1 to 4} haloalkyl group; and
each R³ is an independently selected H, C_{1 to 4} alkyl, or C_{1 to 4} haloalkyl group; and
wherein
each C_{1 to 4} alkyl or haloalkyl group is independently selected to comprise 1, 2, 3, or 4 carbon atoms and may be linear or branched,
each C_{2 to 8} alkyl group is independently selected to comprise 2, 3, 4, 5, 6, 7, or 8 carbon atoms and may be linear or branched,
each C_{6 to 20} alkyl group is independently selected to comprise 6, 7, 8, 9, 10, 11, 12, 13, 14, 15, 16, 17, 18, 19, or 20 carbon atoms and may be linear or branched,
each C_{1 to 10} alkyl, alkoxy, haloalkoxy, or haloalkyl group is independently selected to comprise 1, 2, 3, 4, 5, 6, 7, 8, 9, or 10 carbon atoms and may be linear or branched, and
each C_{1 to 20} alkyl or cycloalkyl group is independently selected to comprise 1, 2, 3, 4, 5, 6, 7, 8, 9, 10, 11, 12, 13, 14, 15, 16, 17, 18, 19, or 20 carbon atoms and may be linear or branched.

11. The method of claim 10, wherein the particles are treated with a silanizing agent that comprises a vinyl group.

12. The method of claim 1, wherein the internally lubricated cured coating has a greater amount (per cubic volume) of the second lubricating fluid at or on a portion of the exposed surface of the cured coating than the amount of second lubricating fluid within said portion of the internally lubricated cured coating.

13. The method of claim 1, wherein some or substantially all of HP-particles are covalently bound to the internally lubricated cured coating.

14. The method of claim 1, wherein the internally lubricated cured coating displays hydrophobic properties.

15. The method of claim 1, wherein the internally lubricated cured coating has a water roll off angle that is less than 16, 14, 12, 10, 9, 8, 7, 6, 5, 4, 3, 2, or 1 degrees.

16. The method of claim 1, wherein the internally lubricated cured coating has a Shore A hardness from about 10 to about 80 or has an ASTM D 3363-00 hardness from about 6B to about 6H.

17. The method of claim 1, wherein the coating of the pre-polymer composition is applied to all or part of the substrate as a layer from about 20 microns to about 750 microns.

18. The method of claim 1, wherein the pre-polymer composition optionally comprises one or more solvents and has a viscosity less than 10,000 cSt as determined by ASTM D5125-10.

19. The method of claim 17, wherein greater than 85%, 90%, 95%, 96%, 97%, 98% or 99% of the cured coating's exposed surface is prevented from fouling by tightly adherent material for up to 100 days of submersion in fresh water, brackish water, or seawater environment at a depth of 1-2 meters.

20. A method of preventing fouling of all or part of a substrate immersed in a fresh water, brackish water, or seawater environment by forming an internally lubricated coating on the substrate, the method comprising;
i) combining polymerizable monomers, functionalized oligomers, and/or functionalized polymers, which can be polymerized to prepare silicone elastomers, and HP-particles with a first lubricating fluid to form an internally lubricated pre-polymer composition and applying the composition to a substrate to form a coating of the pre-polymer composition on all or part of the substrate;
ii) curing the coating of the internally lubricated pre-polymer composition by polymerizing the monomers, functionalized oligomers, and/or functionalized polymers to form a cured coating having a surface; and
iii) applying a second lubricating fluid to all or part of the surface of the cured coating, thereby forming an internally lubricated cured coating having an exposed surface;
wherein the first lubricating fluid comprises greater than 10% of the total weight of the monomers, functionalized oligomers, functionalized polymers, all particles present in the pre-polymer composition, and the first lubricating fluid; and
wherein greater than 70%, 75%, 80%, 85%, 90%, 95%, 96%, 97%, 98% or 99% of the cured coating's exposed surface is free of fouling by tightly adherent material for up to 100 days of submersion in fresh water, brackish water, or seawater environment at a depth of 1-2 meters.
